(19) United States
(12) Patent Application Publication
(10) Pub. No.: US 2023/0093741 A1
(43) Pub. Date: Mar. 23, 2023

(54) SIGNAL PROCESSING METHODS AND APPARATUS

(71) Applicant: Triad National Security, LLC, Los Alamos, NM (US)

(72) Inventor: Neil Edward LOYCHIK, Los Alamos, NM (US)

(21) Appl. No.: 17/947,966

(22) Filed: Sep. 19, 2022

Related U.S. Application Data
(60) Provisional application No. 63/245,654, filed on Sep. 17, 2021.

(51) Int. Cl. G01H 1/00

(52) U.S. Cl. CPC G01H 1/003; G01M 1/22

(57) ABSTRACT

A signal processing method and apparatus quantifies signal “character” in the frequency domain from highly complex signals in a statistically consistent manner. Particular aspects focus on spectral density analyses such as skewness spectral density (SSD), kurtosis spectral density KSD), and probability spectral density (PDSD), among other types of spectral density. Applications of the inventive technique enable not only identification of signal characteristics, but also quantification of signal behavior in an explainable way. Higher orders of spectral densities are 1) physical and statistical, 2) convergent with boundable error, 3) integrable and relatable to the time-domain, and 4) typically differentiable.

### CROSS-REFERENCE TO RELATED APPLICATIONS

The present application claims the benefit of U.S. Provisional Application No. 63/245,654, filed Sep. 17, 2021, and incorporates the entire contents of that provisional application by reference.

### ACKNOWLEDGMENT OF GOVERNMENT SUPPORT

This invention was made with government support under Contract No. 89233218CNA000001 awarded by the U.S. Department of Energy/National Nuclear Security Administration. The government has certain rights in the invention.

### BACKGROUND OF THE INVENTION

Aspects of the present invention relate to signal processing. More particularly, aspects of the present invention relate to a signal processing method enabling more effective interpretations of complex signals than current methods can achieve. Even more specifically, aspects of the present invention relate to a signal processing method enabling greater signal explainability, yielding more reliable and actionable interpretation of a wide variety of signals, and obtaining more actionable intelligence from signals analysis in a generally application-agnostic manner, in contrast to current application-specific signal processing methods. The described signal processing techniques are applicable in many different fields (engineering, science, and finance) and different applications (sound recognition, equipment diagnostics, structural modeling, quantitative finance, etc.)

A common signal processing method, in vogue for over a century, employs power spectral density (PSD) analysis, which is the frequency-domain decomposition of signal variance (power) for a random stationary and ergodic source. A review of the literature reveals the only spectral density techniques employed in the area of signal processing have involved PSD.

PSD is 1) physical and statistical, 2) convergent with boundable error, 3) integrable and relatable to the time-domain, and 4) typically differentiable. These characteristics make PSD a valid boundary condition for simulations and testing. However, PSD and other traditional signal processing methods are not always easy to interpret. For example, in machinery failure analysis, a machine heading toward a failure mode might output different sounds of similar pitch and volume, or different vibrations. A trained ear might or might not recognize that the different sounds or vibrations connote potential failure. PSD does not enable that kind of recognition.

As another example, the timbre between two musical instruments can be different, but the PSD measures the same pitch and volume, so that PSD analysis of two instruments (for example, piano and cello) playing the same notes at the same time does not yield easy differentiation.

A similar issue applies when encountering the “cocktail party problem,” which can arise in different contexts, from multiple people speaking over each other, to multiple machines running in a noisy machine room. Distinguishing the different sounds and/or vibrations is difficult. Conventional application of PSD to this problem does not yield easy differentiation, just as that application does not yield easy differentiation with simultaneously playing musical instruments.

In these examples and others, it is possible to remedy this differentiation problem by applying AI to PSD (in the case of voice, for example, using voice recognition platforms such as those coming from Google or Apple). However, the analog nature of sound signals, and the lack of differentiability when such signals overlap each other, means that the training sets necessary for AI to provide reliable results have to be substantial.

In these and other cases, reliability of results stems from a general assumption that frequency-domain content is sinusoidal or Gaussian (bell curve), even though ordinarily skilled artisans understand that many frequency-domain problems are non-Gaussian (not a bell-shaped curve).

It would be desirable to be able to extract and quantify the non-Gaussian behavior present, in many sound signals, in a wide variety of applications.

### SUMMARY OF THE INVENTION

To address the foregoing and other issues, aspects of the present invention provide a signal processing method that quantifies signal “character” in the frequency domain from highly complex signals in a statistically consistent manner. Particular aspects focus on spectral density analyses such as skewness spectral density (SSD), kurtosis spectral density (KSD), and probability spectral density (PDSD). Other types of spectral density may provide relevant information as well.

As a result, applications of the inventive technique enable not only identification of signal characteristics (for example, the difference between a trumpet and a violin), but also quantification of signal behavior in an explainable way. Like PSD, higher orders of spectral densities discussed herein are useful in a number of practical applications because they are 1) physical and statistical, 2) convergent with boundable error, 3) integrable and relatable to the time-domain, and 4) typically differentiable.

The inventive techniques are useful across many different professional disciplines requiring signal processing. Aspects of the inventive techniques can be used in conjunction with AI algorithms to make AI results more useful. One of the problems with AI is that the results are only as good as the training sets used. When trained AI algorithms applied to data, the algorithms tend to latch on to small differences, and therefore potentially stray in a direction away from the actual results. By providing more focused and specific data in accordance with aspects of the invention—for example, KSD, employing kurtosis, will identify extremes in a distribution or data set—it is possible to focus the AI algorithms with smaller training sets and yield better results.

To achieve the foregoing and other objects, embodiments according to aspects of the present invention provide a computer-implemented signal processing system to analyze vibrations in machinery, the computer-implemented signal processing system comprising: one or more sensors to receive input vibration signals from the machinery; and a computer-implemented signal processor to receive the input vibration signals from the one or more sensors, to process the input vibration signals, and to output one of skewness spectral density (SSD), kurtosis spectral density (KSD), or probability density spectral density (PDSD) analysis of the input vibration signals to enable identification of an operational status of one or more components of the machinery.

In embodiments of the above-mentioned computer-implemented signal processing system to analyze vibrations in machinery, the identification indicates prospective failure of one or more of the components of the machinery. The machinery may comprise apparatus selected from the group consisting of a pump, a compressor, a fan, an engine, or one or more components from said apparatus, said one or more components selected from the group consisting of a valve, an opening or orifice, or a joint. The operational status may include fluid flow through one of the pump, compressor, engine, or one or more components from said apparatus.

Other embodiments according to aspects of the present invention provide a computer-implemented signal processing system to analyze sound, the computer-implemented signal processing system comprising: one or more sensors to receive input sound signals; and a computer-implemented signal processor to receive the input sound signals, to process the input sound signals, and to output one of skewness spectral density (SSD), kurtosis spectral density (KSD), or probability density spectral density (PDSD) analysis of the input sound signals to enable distinction among sounds represented by the input sound signals.

In embodiments of the above-mentioned computer-implemented signal processing system to analyze sound, the distinction among sounds includes differentiation of each of the sounds from the remaining sounds. In some embodiments, the differentiation may comprise an identification of sound differences among machinery. The machinery may comprise apparatus selected from the group consisting of a pump, a compressor, a fan, an engine, or one or more components from said apparatus, said one or more components selected from the group consisting of a valve, an opening or orifice, or a joint. In other embodiments, the differentiation may comprise an identification of a timbre of a voice of each of a plurality of individuals. In yet other embodiments, the differentiation may comprise an identification of different ones of a plurality of musical instruments.

Other embodiments according to aspects of the present invention provide a computer-implemented signal processing system to analyze vibrations in structures, the computer-implemented signal processing system comprising: one or more sensors to receive input vibration signals from the structures; and a computer-implemented signal processor to receive the input vibration signals from the one or more sensors, to process the input vibration signals, and to output one of skewness spectral density (SSD), kurtosis spectral density (KSD), or probability density spectral density (PDSD) analysis of the input vibration signals to enable identification of a condition of one or more components of the structures.

In embodiments of the above-mentioned computer-implemented signal processing system to analyze vibrations in structures, the identification indicates prospective failure of one or more of the components of the structures. The one or more sensors may be selected from the group consisting of accelerometers or other acceleration sensors, vibrometers or other vibration sensors, strain gauges, pressure sensors, flow sensors, acoustic sensors, and microphones.

Other embodiments according to aspects of the present invention provide a computer-implemented signal processing system to perform quantitative financial analysis, the computer-implemented signal processing system comprising: a computer-implemented signal processor to receive input financial data, to process the input financial data, and to output one of skewness spectral density (SSD), kurtosis spectral density (KSD), or probability density spectral density (PDSD) analysis of the input financial data to identify trends in the financial data.

Other embodiments according to aspects of the present invention provide a computer-implemented signal processing system to simulate turbulence, the computer-implemented signal processing system comprising: a computer-implemented signal processor to receive input turbulence data from a turbulence source, to process the input turbulence data, and to output one of skewness spectral density (SSD), kurtosis spectral density (KSD), or probability density spectral density (PDSD) analysis of the input turbulence data to identify characteristics of the turbulence.

Other embodiments according to aspects of the present invention provide a computer-implemented signal processing method to analyze vibrations in machinery, the computer-implemented signal processing method comprising: receiving input vibration signals of the machinery from one or more sensors; receiving, via a computer-implemented signal processor, the input vibration signals from the one or more sensors; processing, via the computer-implemented signal processor, the input vibration signals; and outputting one of skewness spectral density (SSD), kurtosis spectral density (KSD), or probability density spectral density (PDSD) analysis of the input vibration signals to enable identification of an operational status of one or more components of the machinery.

In embodiments of the above-mentioned computer-implemented signal processing method to analyze vibrations in machinery, the identification may indicate prospective failure of one or more of the components of the machinery. The machinery may comprise apparatus selected from the group consisting of a pump, a compressor, a fan, an engine, or one or more components from said apparatus, said one or more components selected from the group consisting of a valve, an opening or orifice, or a joint. The operational status may include fluid flow through one of the pump, compressor, engine, or one or more components from said apparatus.

Other embodiments according to aspects of the present invention provide a computer-implemented signal processing method to analyze sound, the computer-implemented signal processing method comprising: receiving input sound signals from one or more sensors; receiving, via a computer-implemented signal processor, the input sound signals from the one or more sensors; processing, via the computer-implemented signal processor, the input sound signals; and outputting one of skewness spectral density (SSD), kurtosis spectral density (KSD), or probability density spectral density (PDSD) analysis of the input sound signals to enable distinction among sounds represented by the input sound signals.

In embodiments of the above-mentioned computer-implemented signal processing method to analyze sound, the distinction among sounds may include differentiation of each of the sounds from the remaining sounds. The differentiation may comprise an identification of sound differences among machinery. The machinery may comprise apparatus selected from the group consisting of a pump, a compressor, a fan, an engine, or one or more components from said apparatus, said one or more components selected from the group consisting of a valve, an opening or orifice, or a joint. In other embodiments, the differentiation may comprise an identification of a timbre of a voice of each of a plurality of individuals. In yet other embodiments, the differentiation may comprise an identification of different ones of a plurality of musical instruments.

Other embodiments according to aspects of the present invention provide a computer-implemented signal processing method to analyze vibrations in structures, the computer-implemented signal processing method comprising: receiving input vibration signals from the structures from one or more sensors; receiving, via a computer-implemented signal processor, the input vibration signals from the one or more sensors; processing, via the computer-implemented signal processor, the input vibration signals; and outputting one of skewness spectral density (SSD), kurtosis spectral density (KSD), or probability density spectral density (PDSD) analysis of the input vibration signals to enable identification of a condition of one or more components of the structures.

In embodiments of the above-mentioned computer-implemented signal processing method to analyze vibrations in structures, the identification may indicate prospective failure of one or more of the components of the structures. The one or more sensors may be selected from the group consisting of accelerometers or other acceleration sensors, vibrometers or other vibration sensors, strain gauges, pressure sensors, flow sensors, acoustic sensors, and microphones.

Other embodiments according to aspects of the present invention provide a computer-implemented signal processing method to perform quantitative financial analysis, the computer-implemented signal processing method comprising: receiving, via a computer-implemented signal processor, input financial data; processing, via the computer-implemented signal processor, the input financial data; and outputting one of skewness spectral density (SSD), kurtosis spectral density (KSD), or probability density spectral density (PDSD) analysis of the input financial data to identify trends in the financial data.

Other embodiments according to aspects of the present invention provide a computer-implemented signal processing method to simulate turbulence, the computer-implemented signal processing method comprising: receiving, via a computer-implemented signal processor, input turbulence data from a turbulence source; processing, via the computer-implemented signal processor, the input turbulence data; and outputting one of skewness spectral density (SSD), kurtosis spectral density (KSD), or probability density spectral density (PDSD) analysis of the input turbulence data to identify characteristics of the turbulence.

In embodiments of the above-described computer-implemented signal processing system and method, the SSD may be computed as follows:

$${S}_{xx} ( f ) = \frac{d}{df} \frac{{μ}_{3} ( f )}{{( {μ}_{2} ( f ) )}^{\frac{3}{2}}}$$

where

Sₓₓ is SSD;

f is a continuous or a discrete frequency;

μ₂ is a scalar for a second central moment; and

μ₃ is a scalar for a third central moment.

In embodiments of the above-described computer-implemented signal processing system and method, the KSD may be computed as follows:

$${K}_{xx} ( f ) = \frac{d}{df} \frac{{μ}_{4} ( f )}{{( {μ}_{2} ( f ) )}^{2}}$$

where

Kₓₓ is KSD;

f is a continuous or a discrete frequency;

μ₂ is a scalar for a second central moment; and

μ₄ is a scalar for a fourth central moment.

In embodiments of the above-described computer-implemented signal processing system and method, the PDSD may be computed as follows:

$${P}_{xx} ( f ) = \frac{d}{df} P ( x , f )$$

where
Pₓₓ is PDSD;
f is a continuous or a discrete frequency;
P is probability density; and
x is a point on a waveform corresponding to the signals or data.

In embodiments of the above-described computer-implemented signal processing system and method, the computer-implemented signal processor may comprise at least one processor and non-transitory memory to store inputs to the at least one processor, the non-transitory memory storing a plurality of instructions which, when executed by the at least one processor, perform the one of the SSD, KSD, and PDSD.

### BRIEF DESCRIPTION OF THE DRAWINGS

The patent or application file contains at least one drawing executed in color. Copies of this patent or patent application publication with color drawings will be provided by the Office upon request and payment of the necessary fee.

Embodiments according to aspects of the present invention now will be described in detail with reference to the accompanying drawings, in which:

FIG. 1 is a table of equations for implementing the inventive signal processing techniques and systems according to an embodiment;

FIG. 2 is a high level diagram depicting aspects of implementation of the inventive signal processing techniques and systems according to an embodiment;

FIG. 3 is a chart describing aspects of the inventive signal processing techniques and systems according to an embodiment;

FIG. 4 is a high-level block diagram of a signal processing system to analyze machinery vibrations according to an embodiment;

FIG. 5 is a graph explaining aspects of the inventive signal processing techniques and systems according to an embodiment;

FIG. 6 is a graph explaining aspects of the inventive signal processing techniques and systems according to an embodiment;

FIG. 7 is a high-level block diagram of a signal processing system to analyze sound from musical instruments according to an embodiment;

FIGS. 8A and 8B are graphs explaining aspects of the inventive signal processing techniques and systems according to an embodiment;

FIGS. 9A and 9B are graphs explaining aspects of the inventive signal processing techniques and systems according to an embodiment;

FIGS. 10A to 10D are graphs explaining aspects of the inventive signal processing techniques and systems according to an embodiment;

FIG. 11 is a graph explaining aspects of the inventive signal processing techniques and systems according to an embodiment;

FIGS. 12A to 12C are graphs explaining aspects of the inventive signal processing techniques and systems according to an embodiment;

FIG. 13 is a graph explaining aspects of the inventive signal processing techniques and systems according to an embodiment;

FIG. 14 is a high level diagram explaining aspects of the inventive signal processing techniques and systems according to an embodiment;

FIGS. 15-20 are graphs explaining aspects of the inventive signal processing techniques and systems according to an embodiment; and

FIGS. 21A-21C, 22A-22C, 23A-23C, 24A-24C, and 25A-25C are graphs explaining aspects of the inventive signal processing techniques and systems according to an embodiment.

### DETAILED DESCRIPTION OF EMBODIMENTS

In the following discussion, a distinction should be kept in mind when comparing embodiments of the present disclosure and conventional signal processing. Existing literature contains references to concepts such as spectral skewness and spectral kurtosis. In general, descriptors like variance, skewness, and kurtosis are simplifications of probability density. Variance is the relative width of the distribution. Skewness is the tendency toward one side. Kurtosis is the propensity for extreme values. Concepts such as spectral skewness and spectral kurtosis relate to dispersions of power within a frequency bin of the PSD. These concepts do not relate to frequency domain-based signal statistics of the type discussed herein. The following discussion focuses on different kinds of spectral densities, which are compared and contrasted to power spectral density (PSD), which provides information about pitch and volume, but not the kind of information that enables sound differentiation.

As an explicit example, the following table distinguishes kurtosis spectral density (KSD), one of the techniques discussed in detail herein, with spectral kurtosis:

| Kurtosis Spectral Density | Spectral Kurtosis |
|---|---|
| ${K}_{xx} ( f ) = \frac{d}{d f} \frac{{μ}_{4} ( f )}{{( {μ}_{2} ( f ) )}^{2}}$ | $S K ( f ) = \frac{〈 \vert x ( t ) {\vert}^{4} 〉}{{〈 {x ( t )}^{2} 〉}^{2}} - 2$ |

Before proceeding to a discussion of several practical physical applications of the inventive techniques described herein, the following is a discussion of relationships between various spectral densities, such as skewness spectral density (SSD), kurtosis spectral density (KSD), and probability spectral density (PDSD) to PSD.

Over 100 years ago, power spectral density was defined as follows:

$${G}_{xx} ( f ) {=}^{def} \frac{1}{T ( f ( a ) - f ( b ) )} {\int }_{0}^{T} {x ( t , {f}_{ab} )}^{2} dt \qquad ( 1 )$$

$${G}_{xx} ( f ) = {\int }_{- ∞}^{∞} {R}_{xx} ( t ) {e}^{- 2 π ift} dt$$

where Rₓₓ(t) is the autocorrelation of a real, stationary signal x(t).

Equation (1) describes the variance of a waveform that enters an ideal band-pass filter f_{ab} where the difference between a and b is known as the frequency resolution bandwidth centered on f. Equation (1) may be referred to as a filtering-squaring-averaging approach toward spectral density estimation and does not require a Fourier transform to compute. The absence of a Fourier transform clearly shows the power spectrum as the variance (μ₂) between two cutoff frequencies of a band-pass filter. The variance of the band-passed waveform can be rewritten as the difference in variance between two low-pass filters: (μ₂ (x(f_{ab}))=μ₂(f_{b})−μ₂ (fₐ)). Consequently, PSD can be written as the change in variance over the change in frequency, which implies that the PSD can be defined as a derivative of variance with respect to frequency:

$${G}_{xx} ( f ) {=}^{def} \frac{{μ}_{2} ( x ( {f}_{ab} ) )}{f ( b ) - f ( a )} \qquad ( 2 )$$

$$= \frac{{μ}_{2} ( x ( {f}_{b} ) ) - {μ}_{2} ( x ( {f}_{a} ) )}{f ( b ) - f ( a )}$$

$$= \frac{d {μ}_{2} ( f )}{df} as a \to b$$

If this formulation is integrated over all frequencies, the result is Parseval's relationship as applied to the PSD:

$${\int }_{0}^{∞} \frac{d {μ}_{2} ( f )}{df} df = {μ}_{2} = {\int }_{0}^{∞} {G}_{xx} ( f ) df \qquad ( 3 )$$

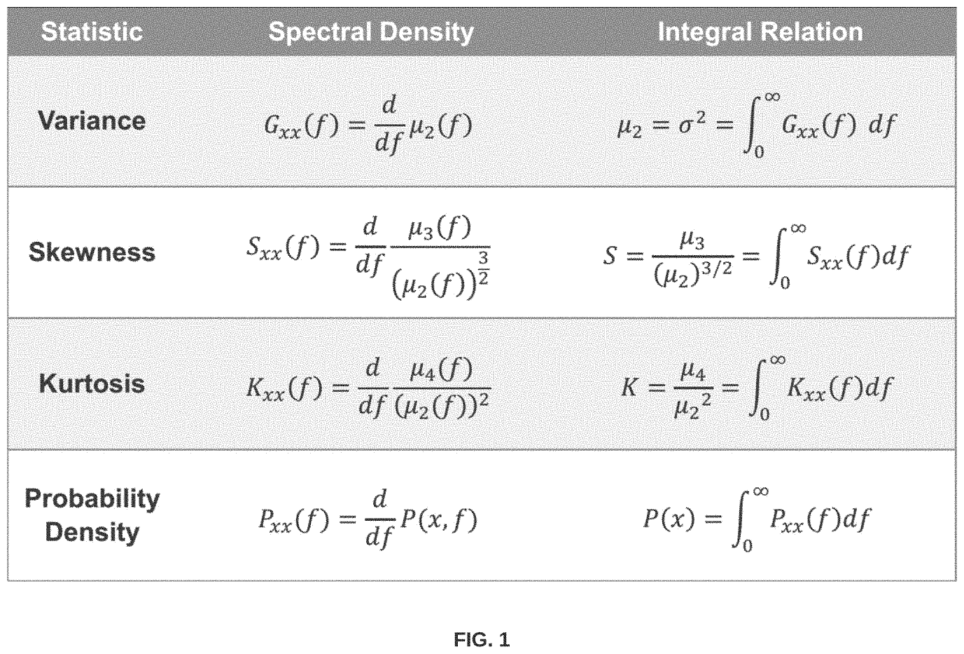

Embodiments of the present invention replace the second moment (μ₂) in equation (3) with higher moments like μ₃ or μ₄, higher standardized moments such as skewness (μ₃/μ₂^{3/2}) and kurtosis (μ₄/μ₂²), or the probability density (P), to yield a skewness spectral density (SSD), a kurtosis spectral density (KSD), and a probability density spectral density (PDSD), respectively, all of which are functions of frequency. Ordinarily skilled artisans will appreciate that this concept of a frequency derivative can be applied with other moments and standardized moments to arrive at other spectral densities. The description herein focuses on SSD, KSD, and PDSD, to show applicability of the disclosed technique in a number of physical applications. Their formulations and integral relations are set forth in FIG. 1.

Assuming that a spectral density is the derivative of signal information with respect to frequency, then the units for a spectral density would be units of the statistic per frequency. Thus, if FIG. 1 were calculated on vibration with an accelerometer (units in g's), then the spectral densities for variance, skewness, kurtosis, and probability density would have units g2/Hz, −/Hz, −/Hz, and −/g·Hz respectively.

The spectral densities of FIG. 1 are defined by differentiation. The integral relations in FIG. 1 are the Parseval-like relationships that show a conservation of information between the frequency and time domains.

From the foregoing, it can be appreciated that aspects of the present invention take advantage of the validity of the frequency derivative for spectral densities of variance, skewness, kurtosis, and the probability density. As a standardized moment is created from central moments, such as μ₃ and μ₄, ordinarily skilled artisans can appreciate that central moments also may be valid for providing a spectral density.

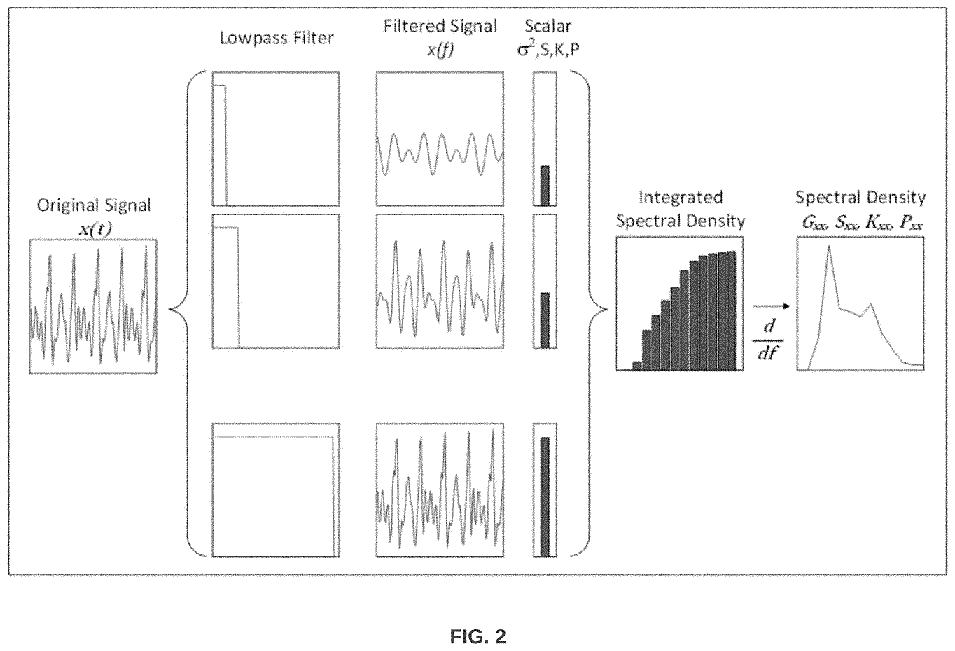

Aspects of a method of implementing a frequency derivative for a discrete signal may be understood with reference to FIG. 2, using the frequency derivatives in the middle column in FIG. 1. In FIG. 2, an input original signal x(t) may enter a filter ensemble or filter “bank” comprising a plurality of low-pass filters, of different respective cutoff frequencies, with sharp roll-offs after a cutoff frequency, to produce a plurality of respective filtered signals x(f) that are functions of frequency. Importantly, the filtered signals x(f) retain non-sinusoidal properties of the original signal x(t). In FIG. 2, three such lowpass filters are shown in the illustrated filter ensemble. However, ordinarily skilled artisans will appreciate that a filter ensemble can have many more, or in some embodiments fewer, such lowpass filters. The integrated spectral density toward the right hand side of FIG. 2, for example, shows many more scalar values than the three shown, indicating a filter ensemble of many more than three lowpass filters. A scalar (variance, skewness, kurtosis, etc.) is calculated for each filtered signal. When arranged by frequency, the scalars become an integrated spectral density. The derivative of the scalar with respect to frequency generates the actual spectral density (PSD, SSD, KSD, etc.), as the right-hand side of FIG. 2 depicts.

In contrast to infinite waveforms, discrete signals as found in physical applications will have error that is quantified as the finite recording in comparison to the theoretical infinite. This requires sample notation, e.g. Ĝₓₓ as the finite estimate of the theoretical Gₓₓ. As the spectral densities for variance, skewness, and kurtosis are functions of central moments, a starting point is the analytical definition of a moment from a dataset with probability density P(x):

μₖ=∫(x−x̅)^{k}P(x) (4)

Which for discrete sampling would have the sample estimate:

$${\hat{μ}}_{k} = {\sum }_{i = 1}^{n} {( x ( i ) - \overline{x} )}^{k} \qquad ( 5 )$$

A difference between the sample (referring to both digital and analog data) and infinite datasets would be:

μₖ=\hat{μ}ₖ±P(μₖ) (6)

Where the sample central moment is the theoretical central moment with an error probability density. The error probability density may be replaced with a standard error, μₖ=\hat{μ}ₖ±ε(\hat{μ}ₖ), but such an equation assumes that P(μₖ) is a Gaussian distribution per the central limit theorem, and would not be valid when bias error is present.

Inserting Equation 6 into the equations of FIG. 1 is straightforward, as the spectral densities are derivatives of moments. Consequently, each spectral density should have its own error probability density:

$$\begin{matrix}{\hat{G}}_{xx} ( f ) = \frac{d}{df} {\hat{μ}}_{2} ( f ) \\ = {G}_{xx} ( f ) \pm P ( {G}_{xx} ( f ) )\end{matrix} \qquad ( 7 )$$

$$\begin{matrix}{\hat{S}}_{xx} ( f ) = \frac{d}{df} \frac{{\hat{μ}}_{3} ( f )}{{{\hat{μ}}_{2} ( f )}^{\frac{3}{2}}} \\ = {S}_{xx} ( f ) \pm P ( {S}_{xx} ( f ) )\end{matrix} \qquad ( 8 )$$

$$\begin{matrix}{\hat{K}}_{xx} ( {f}_{i} ) = \frac{d}{df} \frac{{\hat{μ}}_{4} ( f )}{{{\hat{μ}}_{2} ( f )}^{2}} \\ = {K}_{xx} ( f ) \pm P ( {K}_{xx} ( f ) )\end{matrix} \qquad ( 9 )$$

$$\begin{matrix}{\hat{P}}_{xx} ( f ) = \frac{d}{df} \hat{P} ( x , f ) \\ = {P}_{xx} ( x , f ) \pm P ( {P}_{xx} ( x , f ) )\end{matrix} \qquad ( 10 )$$

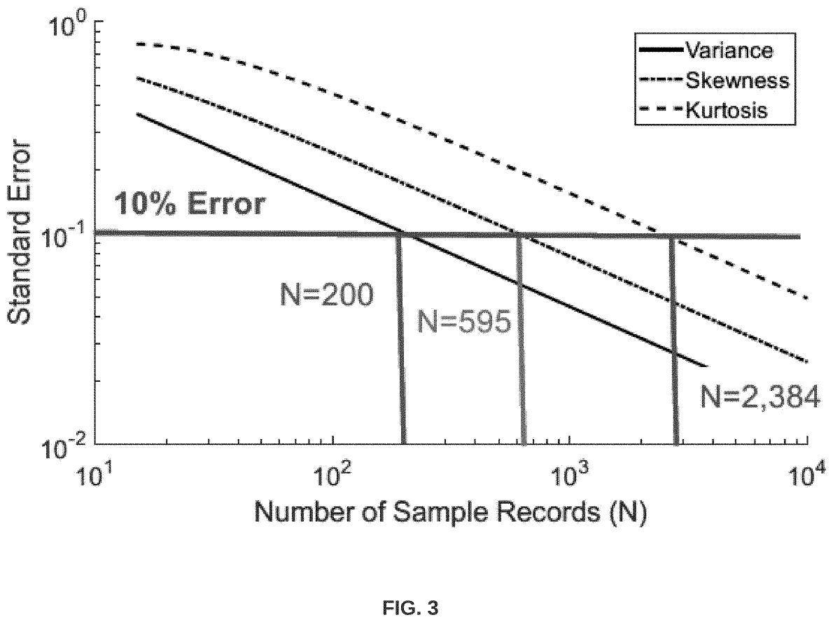

FIG. 3 depicts predicted standard error for estimates of variance, skewness, and kurtosis from unbiased datasets with different sampling. Variance obeys a strict power-law relationship. Skewness and kurtosis obey approximate power-law relationships. Larger amounts of data for higher-moments than lower-moments are necessary in order to obtain accurate measurements. For example, as FIG. 3 depicts, a standard error of 10% would need 200 samples for variance, 595 samples for skewness, and 2,384 for kurtosis.

The derivative definition of a spectral density permits negative values. Though not applicable to the PSD, which is always positive, the SSD, KSD, and PDSD can have negative values, as these are changes to probability, and not reductions in energy. However, common convention is for the PSD to be plotted with a logarithmic scale. Logarithmic scale plotting is not possible with potentially alternating positive and negative values, however. To compensate for this difference, integrated spectral densities are used when necessary, such as the integrated KSD:

$${\int }_{0}^{f} {K}_{xx} ( f ) df = \frac{{μ}_{4} ( f )}{{( {μ}_{2} ( f ) )}^{2}} \approx {\sum }_{i = 0}^{n} {\hat{K}}_{xx} ( f ) δ f \qquad ( 11 )$$

The integrated spectral density is simply the filtered scalar of FIG. 2 and the equations in the middle column of FIG. 1. Interpretation of an integrated spectral density is the scalar at a frequency, e.g. kurtosis at 100 Hz, rather than the scalar contributed by a bin, e.g. kurtosis increased/decreased by some amount.

There are some practical considerations when implementing the filter ensemble approach of FIG. 2, to reduce processing power requirements. Computations are proportional to the number of bins of the spectral density. Consequently, it can be helpful to attempt to reduce the number of frequency bins through custom frequency spacing. One way of doing this is to adopt the following approach (ordinarily skilled artisans will appreciate that other approaches also can be effective):

1) Identify the bandwidth of interest.

Most signals have a middle frequency range of interest, e.g. limited utility of values near 0 Hz and the Nyquist frequency. A Welch PSD of the signal can identify the bandwidth of interest quickly.

2) Use logarithmic spacing in the bandwidth of interest.

Logarithmic spacing can reduce the number of bins in a spectral density. Additionally, as is the case for the PSD, logarithmic spacing is near optimal for general measurements of structural data, and it is assumed that higher-order spectral densities will also have better error properties.

3) Use Linear Spacing Near 0 Hz

Logarithmic scaling over the entire bandwidth of the signal can cause excessive computations calculating the spectral densities of noise near 0 Hz. In embodiments, the first several bins may be linear with a relatively large width. When analyzed, these bins may allow an analyst to confirm noise (e.g. low variance) and integrate to confirm the Parseval-like relationships of the equations on the right-hand side of FIG. 1.

4) Spectral Densities can Stop Before the Nyquist Frequency

The filter ensemble implemented through frequency sampling produces one bin of spectral density at a time. Thus, a spectral density can stop at any frequency before the Nyquist frequency. This may be advantageous if higher frequencies contain noise and do not contribute any more information toward the signal.

As the frequency derivative method defines both the PSD and higher-order spectral densities, it is possible to employ the inventive techniques described herein in most situations that currently use the PSD. Higher-order spectral densities will append knowledge to signals that currently only or predominantly use the PSD. That added knowledge will be physical and statistical, to enable a practitioner to explain a system of interest.

Currently, there are many systems that can benefit from the inventive techniques. Several case studies have been conducted to exemplify the breadth of utility available across a range of disciplines. For illustrative purposes, the following provide some examples of embodiments of the present invention applied to specific technical areas. It should be understood that these examples are non-limiting and embodiments may be used in a variety of applications.

Case Study 1: Rotating Machinery

Different types of machinery have different vibration and acoustic signatures. When a piece of machinery is malfunctioning, or is in danger of malfunctioning, the acoustic signature of the machinery can change. While this change in acoustic signature is a known phenomenon, PSD does not readily enable differentiation of vibrations within the machinery, making it difficult to obtain timely discernment of malfunction or imminent malfunction. One application of embodiments of the present invention enables enhancement of acoustic signatures to enable better predictions. For example, applying the inventive technique to analysis of a pump can enable more accurate discernment of cavitation, signaling failure or imminent failure.

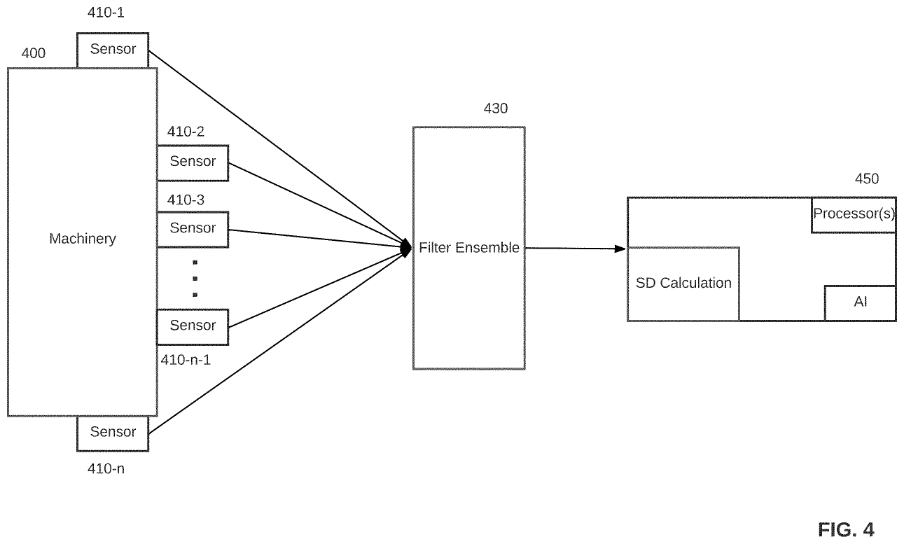

Accordingly, a first case study, discussed herein with reference to FIGS. 4-6, focuses on analysis of machinery vibration, in particular, vibrations in a pump, to identify machinery health. This case study demonstrates the utility of aspects of the present invention in the Industrial Internet of Things (IIoT) and in human-based machine health monitoring.

FIG. 4 depicts, at a high level, the machinery and associated equipment, some or all of which was employed in the study. In FIG. 4, a piece of machinery 400 such as a pump may have one or more sensors 410-1, 410-2, 410-2, . . . , 410-n−1, 410-n placed in various locations producing sounds, vibrations, or other operational attributes to be analyzed. Consistent with the description in FIG. 2, sensor outputs may be provided to a filter ensemble 430, which may comprise a plurality of lowpass filters which may be configured as discussed with respect to FIG. 2.

Outputs of the filter ensemble 430 may be provided to a processing system 450, comprising one or more processors (which may be central processing units (CPUs), graphics processing units (GPUs), or a combination of CPUs and GPUs). The processor(s) include non-transitory memory, including non-transitory storage. Aspects of some embodiments may be implemented in a processing system such as processing system 450.

In embodiments, one or more of the processors may be utilized to calculate any or all of SSD, KSD, PDSD, or other spectral densities which can meet the criteria discussed earlier.

In embodiments, an observer can observe the calculations and interpret the physical and/or statistical behavior from those observations.

In embodiments, one or more of the processors may be utilized to perform artificial intelligence (AI) on the received filter ensemble outputs using one or more AI algorithms. The AI algorithm(s) will have been trained using appropriate training sets, as ordinarily skilled artisans will appreciate, and according to embodiments, may embody any of a variety of categories of machine learning algorithms. In one aspect, the size of the training sets can be reduced because the use of the filter ensemble to reduce the volume of data involved.

One of the principles underlying this case study is that much machinery operates with a rotating shaft to supply power for a particular process, for example, to pump liquids from one location to another. The rotating shafts used in such machinery are almost never perfectly balanced. As a result, there will almost always be some rotating eccentric mass that will produce a sine wave in the vibration. The process side of the machinery will have friction and reaction forces in the form of random vibrations. Sine-on-random environments can be found with most rotating equipment involving fluid handling, where the turbulence of the fluid produces random vibrations. Exemplary equipments can include centrifugal pumps, centrifugal compressors, fans, turbine gas engines, and propellers.

In this case study, testing is conducted on an 8 hp Grudfos vertical multistage centrifugal pump. Generally, pumps have high Reynolds numbers (between 104 and 108) near an impeller of the pump, because frictional losses decrease with increasing Reynolds number. With known sources (sine and random), shape of spectral densities in the frequency domain can identify shaft and turbulent behavior. Data is collected continuously, over a period of weeks, with a Crystal Instruments Spider 80X with shielded industrial triaxial accelerometers (PCB 629A31). Segments of 100 seconds ae processed into spectral densities, including PSD, SSD, and KSD.

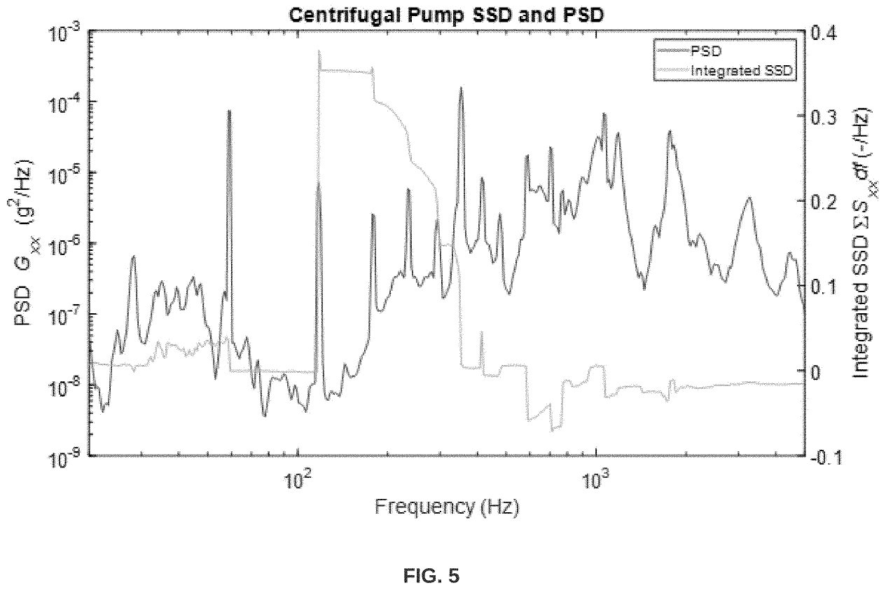

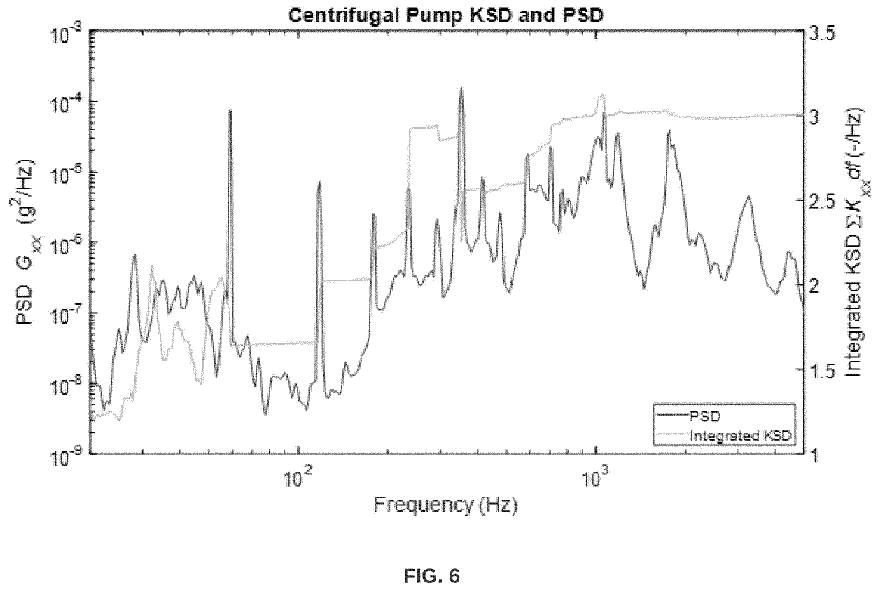

An exemplary part of the dataset is seen in FIG. 5 (comparing PSD and SSD) and FIG. 6 (comparing PSD and KSD). In FIG. 5, there are noticeable features near run speed and vane pass harmonics that induce some positive skewness from 2-times to 6-times run speed before normalizing. Skewness within ±0.5, as in FIG. 5, generally is considered symmetric.

In FIG. 6, the run speed shape is sinusoidal, as shown by an integrated KSD of 1.5 at 60 Hz. After 60 Hz, flow-induced vibration appears to drive the signal to Gaussian behavior with the largest changes to shape appearing near the run speed and harmonics with normalization by 780 Hz with a kurtosis of 3.0. These changes are discontinuities in the frequency domain, meaning that they are sinusoids. FIG. 6 appears to show a transition from mechanical dynamics to fluid dynamics in the frequency domain. At lower frequencies, the PSD shows discrete contributions of energy at run speed and harmonics, which is consistent with the rotodynamics of a spinning shaft. At higher frequencies, the PSD shows random behavior with gradual changes in energy. The KSD supplements this information with discrete shape changes at lower frequencies, followed by gradual changes in shape at higher frequencies.

FIGS. 5 and 6 illustrate an ability to extract physically interpretable information that matches with expectations for a rotodynamic system such as a pump. Such information can indicate sensitivity of the SSD and KSD toward mechanical faults (e.g. misalignment or failed bearing) or operational changes (e.g. flow rate). Impending or actual mechanical faults can cause differences in characteristic sound that a machine produces. The ability of SSD and KSD analysis techniques to recognize such differences can facilitate identification of potential faults in particular machinery components at particular locations. The same analysis, applied to flow rate of a pump (looking, for example, at changes in flow rates), also can indicate possible impending faults of particular pump elements at particular locations.

The case study just discussed focused on aspects of operation of a pump. Different kinds of mechanical equipment, for example, where fluid flow, shaft rotation, or other operational attributes can convey information about state of equipment performance, usefully can take advantage of the techniques described herein. Various kinds of sensors, including but not limited to various kinds of accelerometers and other acceleration sensors; motion sensors; vibrometers and other vibration sensors; strain gauges, acoustic sensors, microphones, flow sensors, radiation sensors, and the like, can provide appropriate information for analysis. Ordinarily skilled artisans will appreciate that the inventive techniques and systems can employ various kinds of sensors.

It should be noted that, while it is possible to employ flow rate sensors as an option to identify flow rate, flow rate sensors can be expensive to obtain and deploy. Flow rate sensors also involve contact with the fluid. Vibration sensors can be much more economical, costing as much as two orders of magnitude less to purchase, being much easier to install (on the outside of a pump or pipe, for example), and not requiring contact with the fluid.

Identification of vibrations in fluid flow using vibration sensors also can be helpful in situations in which the fluid being monitored is unknown. Different fluids can have different vibration signatures, enabling fluid identification through identification of the vibration signatures.

Case Study 2: Musical Instrument Sound Recognition and Separation

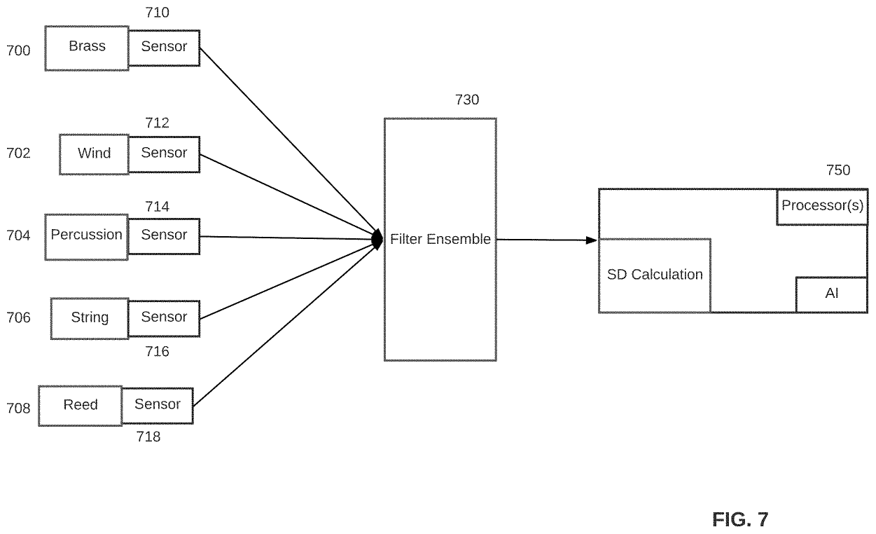

A second case study, discussed herein with reference to FIGS. 7-10D, focuses on analysis of sound from musical instruments, in particular, a trumpet, a flute, a piano, and a violin. FIG. 7 depicts a trumpet as a brass instrument 700, with an associated sensor 710; a flute as a wind instrument 702, with an associated sensor 712; a piano as a percussion instrument 704, with an associated sensor 714; a violin as a string instrument 706, with an associated sensor 716; and a reed instrument 708 (not included in the following discussion, but presented for the sake of completeness), with an associated sensor 718. According to embodiments, one or more of the sensors 710-718 may be microphones. Also, while FIG. 7 depicts each musical instrument or category of musical instruments as having an associated sensor or microphone, in different embodiments, fewer microphones than musical instruments or musical instrument categories, or more microphones than musical instruments or musical instrument categories may be provided.

Consistent with the description in FIG. 2, sensor or microphone outputs may be provided to a filter ensemble 730, which may comprise a plurality of lowpass filters which may be configured as discussed with respect to FIG. 2.

Outputs of the filter ensemble 730 may be provided to a processing system 750, comprising one or more processors (which may be central processing units (CPUs), graphics processing units (GPUs), or a combination of CPUs and GPUs). The processor(s) include non-transitory memory, including non-transitory storage. Aspects of some embodiments may be implemented in a processing system such as processing system 750.

One or more of the processors may be utilized to calculate any or all of SSD, KSD, PDSD, or other spectral densities which can meet the criteria discussed earlier.

One or more of the processors may be utilized to perform artificial intelligence (AI) on the received filter ensemble outputs using one or more AI algorithms. The AI algorithm(s) will have been trained using appropriate training sets, as ordinarily skilled artisans will appreciate, and according to embodiments, may embody any of a variety of categories of machine learning algorithms.

One of the principles underlying this case study is that musical instruments can play identical notes, at nearly identical frequencies and amplitudes, even though the instruments sound different, that is, even though the instruments have different timbres. The characteristic sound (timbre) of an instrument is identifiable to the human ear. This is how the human ear can differentiate among different musical instruments. Signal analysis using PSD does not enable that kind of differentiation, however. As will be discussed herein, KSD does enable that kind of differentiation among different kinds of musical instruments with characteristics as follows:

A piano is a percussion instrument that is excited by an impact of a hammer onto a string. Such impact causes higher extremes than normal, and hence will display high kurtosis (K>3.0).

A violin (a string instrument) and a trumpet (a brass instrument) are reverberant instruments that are excited by frictional rubbing or constricted air flow through a shaped cavity. Such rubbing or air flow causes extremes comparable to normal, i.e. Gaussian kurtosis (K≈3.0).

A flute is a wind instrument comprising a pressurized cylindrical air cavity, which should create a standing wave that has sinusoidal behavior, which would cause lower extremes than normal, or low kurtosis (K<3.0).

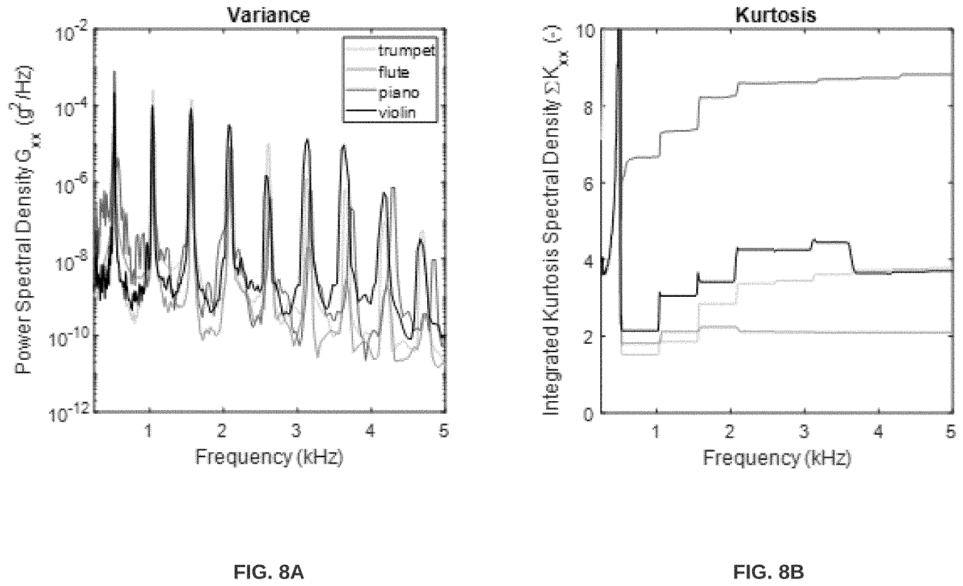

These descriptions provide an intuitive expectation of a signal's kurtosis, where the KSD can possibly permit a more quantitative approach toward perception. A further advantage of musical sounds is that instruments can be evaluated with publicly available data, such as the McGill University Master Samples (MUMS), which may be used for this study. The above-mentioned four musical instruments (flute, violin, trumpet, and piano) are selected. These instruments play C5 (532 Hz), which have waveform kurtoses of 2.1, 3.7, 3.8, and 8.8 respectively. The low kurtosis of the flute matches the assumption of a standing wave. The high kurtosis of a piano matches the assumption of an impact. The violin and trumpet kurtoses are near-identical. When evaluated in the frequency-domain, the integrated KSD of FIG. 8B not only identifies the overall kurtosis (Kxx at 5 kHz), but also segregates all instruments, including the trumpet and violin.

The results in FIG. 8A show that PSD's pitch and volume analysis does not yield data enabling good or adequate differentiation among different instruments playing the same note(s) at the same volume(s). By contrast, FIG. 8B shows that the spectral shape of an integrated KSD is distinct for each instrument. Separation is consistent with how the instrument operates (piano impact: kurtosis>3, flute standing wave: kurtosis<3). The ability to separate sound includes the trumpet and violin, which have near identical signal kurtosis and pitch and volume, but noticeably different KSD curves.

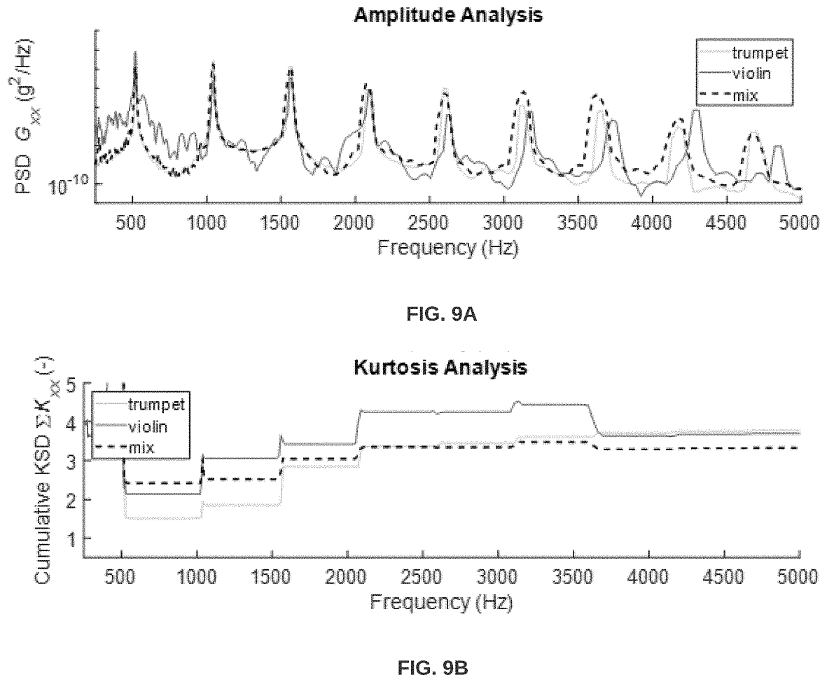

FIGS. 9A and 9B show a situation in which sound from two musical instruments, here a trumpet and a violin, are mixed. FIG. 9A shows a standard amplitude analysis. FIG. 9B shows a KSD analysis. Subjectively, the mixture PSD appears to correlate with the trumpet, meaning source identification from the mixture would be difficult. By contrast, the integrated KSD curves are distinct for the trumpet, the violin, and the mixture. Even though the mixed signal is not necessarily a linear combination of the two other instruments, its distinct properties can provide a basis for source separation.

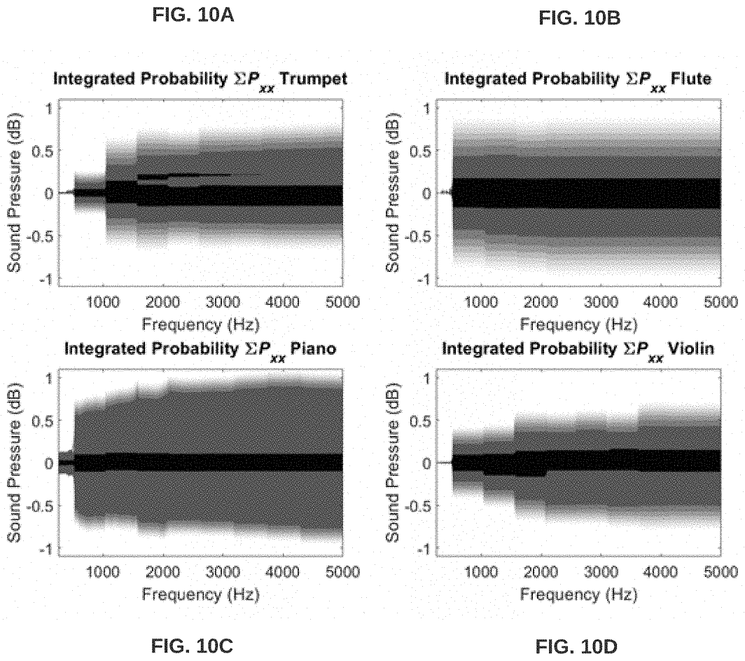

The spectral densities in FIG. 1 can extract more meaningful information of a signal, but such transforms can also extract information of unknown relevance. The PDSD equation could ostensibly contain all frequency-domain features extractable, meaning that the PDSD equation will present convergent and quantifiable features that have unknown properties toward perception. This characteristic is observable in the integrated PDSD (Pxx) as shown in FIGS. 10A-10D.

In FIGS. 10A-10D, an integrated PDSD is the probability density (z-axis) changing with respect to frequency. The PSD, SSD, and KSD would be simplifications of the PDSD. The observable detail provided by the PDSD includes many segregating phenomena, such as the flute being uniform in frequency, the piano having a broad top, and each instrument having unique increases or decreases toward probability at extremes (tails expanding and contracting). Of potential interest is the apparent bimodal behavior of the trumpet from the 3rd to 7th octaves (1,569 Hz to 3,661 Hz).

FIGS. 10A-10D present the amount of information capable of being extracted from a signal in the frequency domain, thus presenting the ability to interrogate a signal more aggressively.

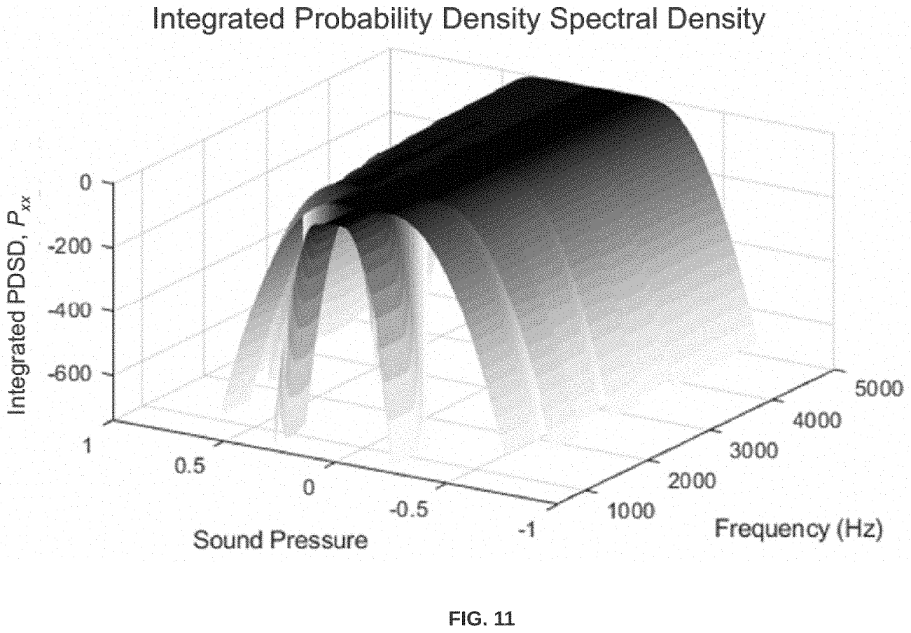

FIG. 11 shows another way of looking at the information that PDSD can provide. In FIG. 11, top, darker portions of the individual curves correspond to the darker portions of FIGS. 10A-10D. FIG. 11 shows, more clearly than do FIGS. 10A-10D, the shape of the sound envelope that a particular musical instrument can make.

Ordinarily skilled artisans will appreciate that the principles that the case study of FIGS. 7-11 reflect also are applicable to voice processing. Voices can speak at the same pitch and volume, but can be difficult to differentiate. This is a phenomenon referred to above as the “cocktail party problem”. Voice signals also are non-sinusoidal, and vary with the voicebox characteristics of the speaker. Just as PDSD, SSD, and KSD can aid in differentiating among musical instruments, these techniques can help to differentiate among different voices speaking simultaneously. The voices may or may not be saying the same things. They may be saying the same things when a musical group is singing, for example. There may be multiple voices in a particular section of the group (e.g. alto, baritone). The inventive techniques can help to distinguish among multiple voices at the same register, just as the techniques help to distinguish among different musical instruments playing the same note(s).

Case Study 3: Turbulent Energy Cascade

This case study was conducted with the John Hopkins Turbulence Database (JHTDB), which is an example of a multi-terabyte open-sourced database with space-time turbulence datasets accessible to researchers. A supercomputer will calculate a turbulent energy cascade, which can be described as a transfer of energy between small and large scales in fluids, by perturbing the data. For unconstrained flow that is not next to a boundary, the energy cascade has a power-law relationship in the spatial and temporal domains. Direct numerical simulation (DNS) can compute, but does not model the energy cascade.

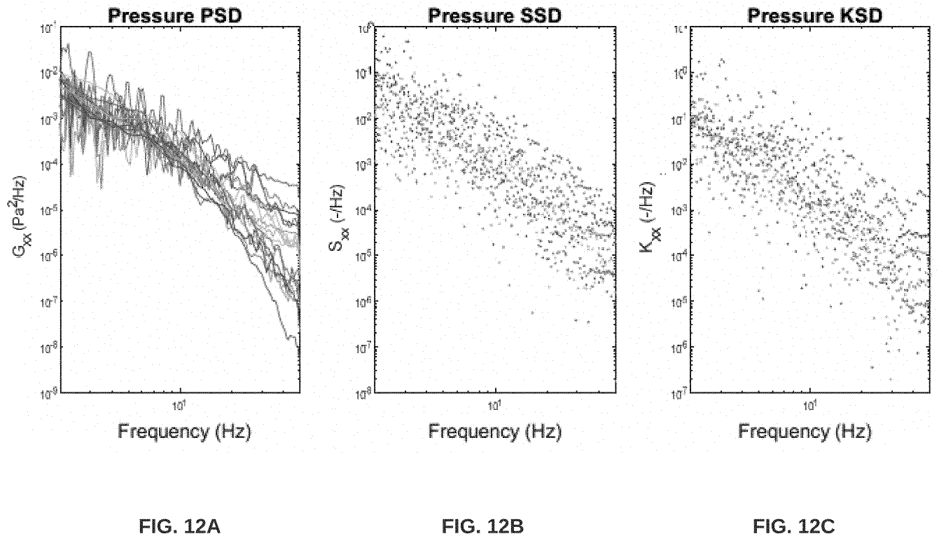

In this case study, from the referenced JHTDB datasets, the forced isotropic turbulence dataset on 4096³ grid was selected for analysis. Nine data temporal waveforms were extracted from that dataset, and were used to calculate the temporal spectral densities seen in FIGS. 12A-12C.

FIGS. 12A-12C depict temporal PSD, SSD, and KSD at multiple points from the John Hopkins DNS dataset. Data points are the eight points of a cube that is half the width of the simulation, and the center of the simulation. The PSD shows the energy cascade as expected. The SSD and KSD cascades appear to alternate randomly between positive and negative values. When graphed as the absolute value, the SSD and KSD points appear to have a power-law slope comparable to the PSD.

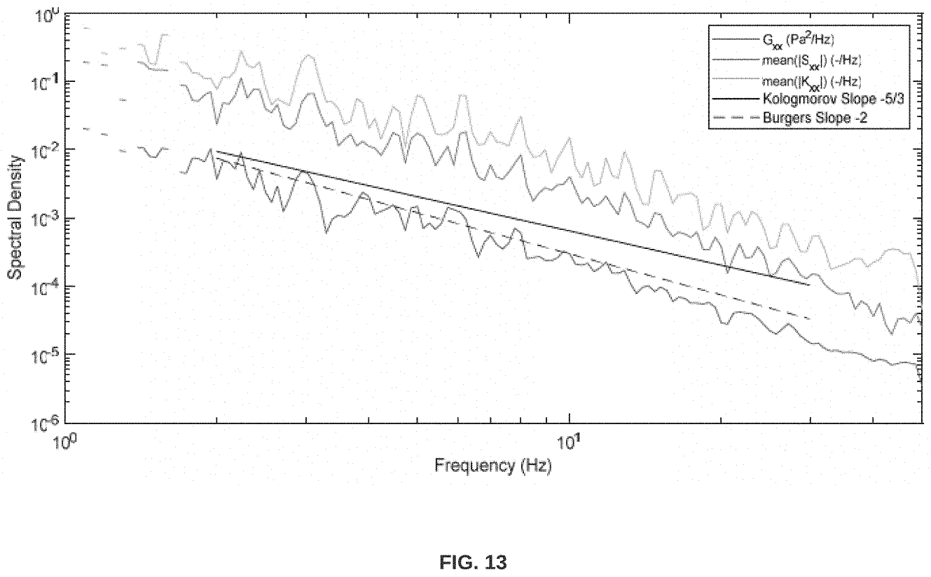

FIG. 13 represents an average of the nine curves of FIGS. 12A-12C. FIG. 13 shows that PSD obeys the −2 power-law relationship that is expected from an energy cascade model. The line signifying the Burgers slope −2 curve is consistent with this. The average absolute values of the SSD and KSD appear to have the same slope. This data may signify some shape property of turbulence, as turbulence has predictable characteristics of its non-Gaussian components in the frequency domain. The slope appears to lie somewhere between the Burgers slope −2 curve and the Kolmogorov slope −5/3 curve.

A goal of this study was to reduce the computational demands normally involved in computing the energy cascade. A particular concern is that computational demands at high frequencies can become the driver for required computational intensity. As ordinarily skilled artisans will appreciate from FIGS. 12A-12C and 13, by adding the SSD and KSD curves, it is possible to eliminate impossible or improbable results, thereby constraining the model and/or reducing the amount of data to be included in the analysis.

Case Study 4: Mass-Spring Damper Transmissibility

Non-Gaussian vibration is known to affect material strain/life differently from Gaussian or sinusoidal vibration. The mass-spring-damper is a foundational structure to enable modeling of mechanical dynamics and understanding resonant response.

Mass-spring damper dynamics often are discussed in terms of mass m, stiffness k, and damping c. These values are related to a natural frequency fₙ of a mass-spring damper system, as well as to a damping ratio ζ. Accordingly, the mass-spring-damper of waveform output (x) from input (y) also may be defined by:

$$\frac{{d}^{2} x}{{dt}^{2}} + 4 ζ π {f}_{n} \frac{dx}{dt} + {( 2 π {f}_{n} )}^{2} x = \frac{{d}^{2} y}{{dt}^{2}} \qquad ( 12 )$$

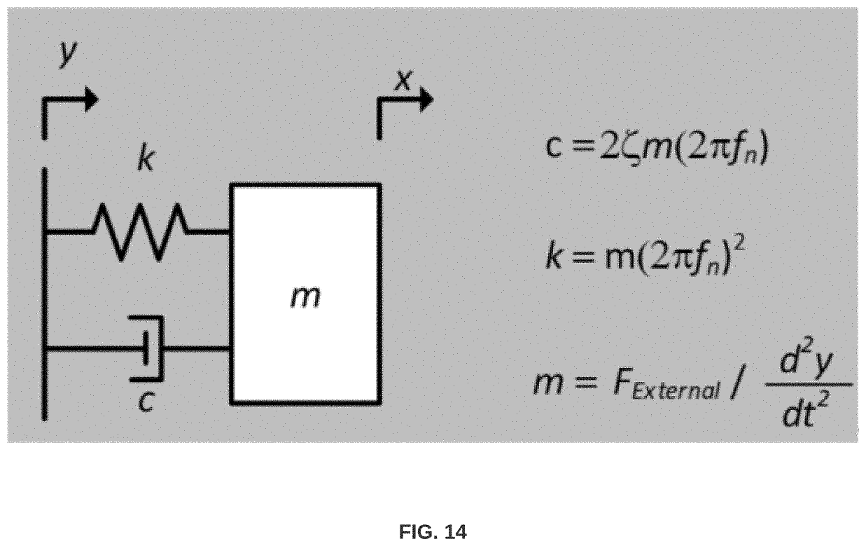

FIG. 14 depicts a mass-spring-damper, including relations among the alternative terminology just mentioned.

An explicit analysis of the mass-spring damper may involve use of a shock response spectrum (SRS) filter to calculate the waveform response of a mass-spring-damper to a vibration, from which power, skewness, and kurtosis is calculated. This analysis would entail a numerical solution of Equation (12). As ordinarily skilled artisans will appreciate, an example of an SRS filter may be found in Smallwood, “An Improved Recursive Formula for Calculating Shock Response Spectra, Shock and Vibration Bulletin,” No. 51, pp. 211-217, May 1981, which is incorporated by reference herein.

In contrast to the numerical approach that the just-described explicit analysis provides, embodiments of the present invention may employ an implicit analysis, using the frequency-domain transmissibility of power, skewness, and kurtosis to calculate the response, as Equations (13)-(15) show.

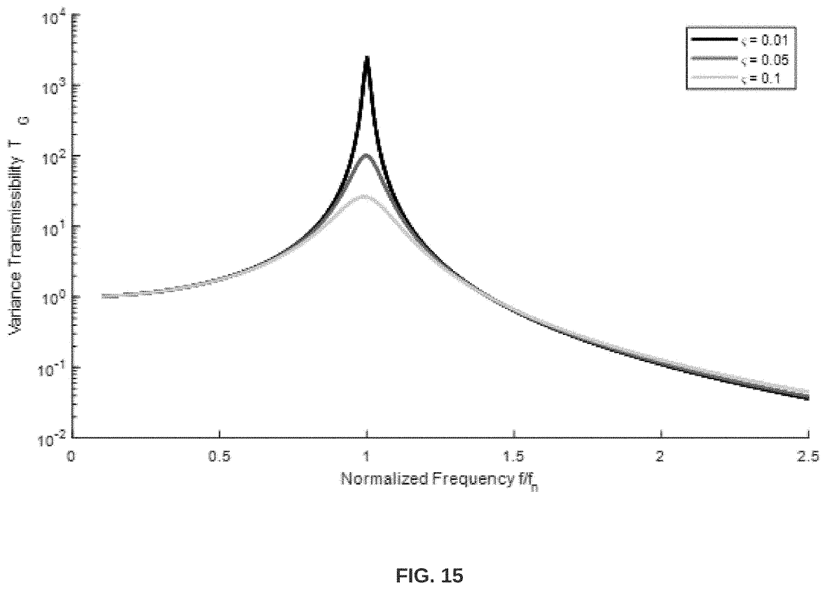

PSD transmissibility has an analytical expression based upon the natural frequency (fₙ) and damping (ζ):

$${T}_{G} ( f ) = {T}_{A}^{2} ( f ) = \frac{{G}_{xx} ( f )}{{G}_{y y} ( f )} = \frac{1 + {( 2 ζ f / {f}_{n} )}^{2}}{1 - {f}^{2} / {f}_{n}^{2} + 4 {ζ}^{2} {f}^{2} / {f}_{n}^{2}} \qquad ( 13 )$$

Where T_{A} is the amplitude or ‘force’ transmissibility, and T_{G} is the variance (PSD) transmissibility, which creates a well-known response curve of FIG. 15, which is a graph of the analytical expression of variance transmissibility in Equation (13). Resonant amplification of variance may be observed at a structure's natural frequency.

One purpose of this case study was to determine whether a transmissibility exists for higher moments by calculating:

$${T}_{S} ( f ) = \frac{{S}_{xx} ( f )}{{S}_{y y} ( f )} \qquad ( 14 )$$

$${T}_{K} ( f ) = \frac{{K}_{xx} ( f )}{{K}_{y y} ( f )} \qquad ( 15 )$$

Where T_{S}(f) denotes SSD transmissibility and T_{K}(f) denotes KSD transmissibility. Equations (14) and (15) amount to an effective substitution of the SSD or KSD transmissibility for the PSD transmissibility.

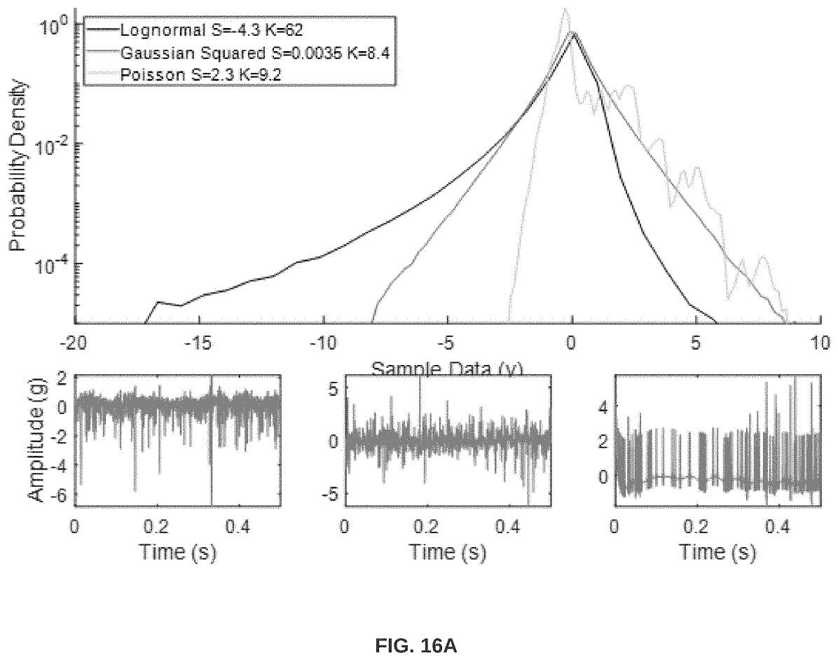

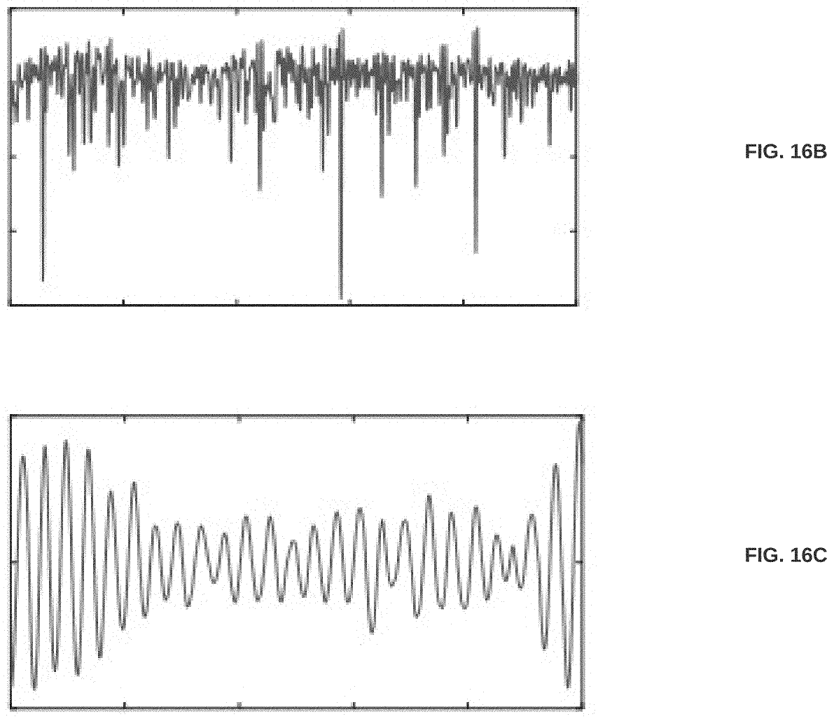

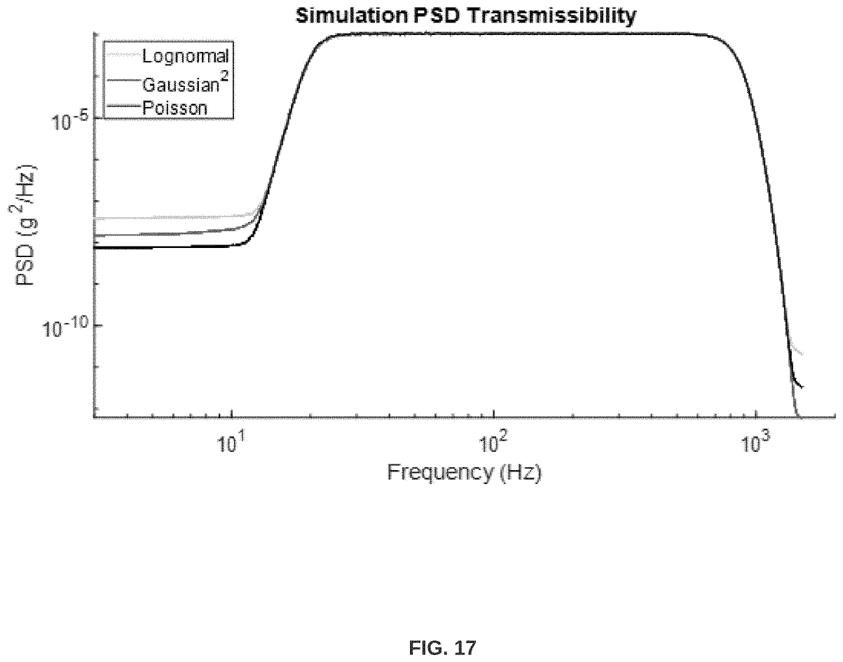

To evaluate the respective transmissibilities, several non-Gaussian waveforms were generated with Matlab's random number generation toolbox: Lognormal (lognrnd), Gaussian (randn) squared, and Poisson (poisson), as seen in FIG. 16A. FIG. 16B shows an input waveform, and FIG. 16C shows an output waveform, corresponding to the imposition of a Smallwood response filter to the input waveform of FIG. 16B. Each dataset underwent the following:
Interpolated and band-pass filtered to simulate a dynamic bandwidth of 20 to 900 Hz;
Comprised of 1,000 seconds of record duration;
Resampled to have a virtual sampling rate of 3,000 Hz with applied units g²/Hz to be representative of vibration and to prevent aliasing;
Scaled to have equivalent PSD amplitude for each waveform as shown in FIG. 17.

The generated data clearly is non-Gaussian, with observable skewness and extremes in the probability density and waveforms. As FIG. 17 shows, three otherwise dissimilar waveforms have similar PSDs.

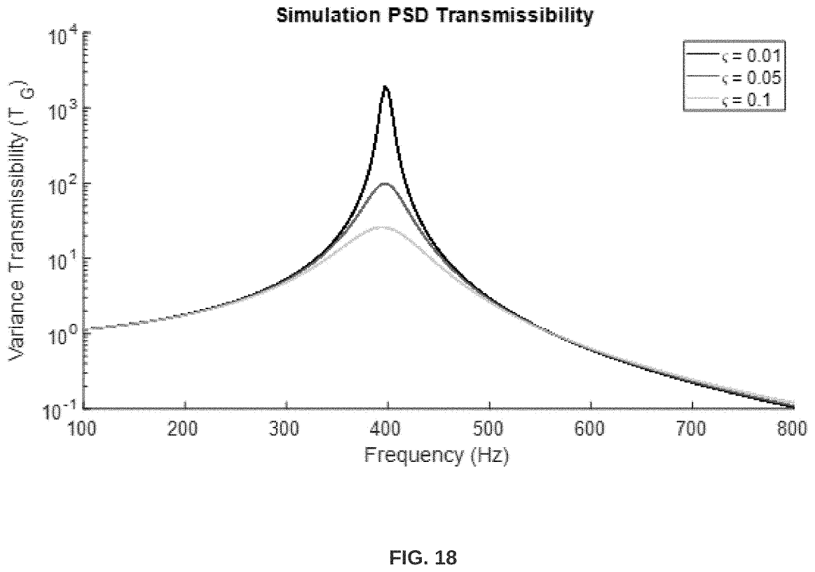

Each input waveform (y) entered a mass-spring-damper filter with a natural frequency of 400 Hz, and a damping of 0.01, 0.05, or 0.1, to produce an output waveform x using a response filter. FIGS. 18-20 show respective results of calculating PSD, SSD, and KSD for x and y to produce PSD, SSD, and KSD transmissibilities.

FIG. 18 shows nine variance transmissibilities, created from Lognormal, Gaussian Squared, or Poisson distributions, as applied to a mass-spring-damper model with natural frequency of 400 Hz and damping of 0.01, 0.05, and 0.1. Only three curves appear in the graph because of overlap. Results are comparable to the analytical graph of FIG. 15.

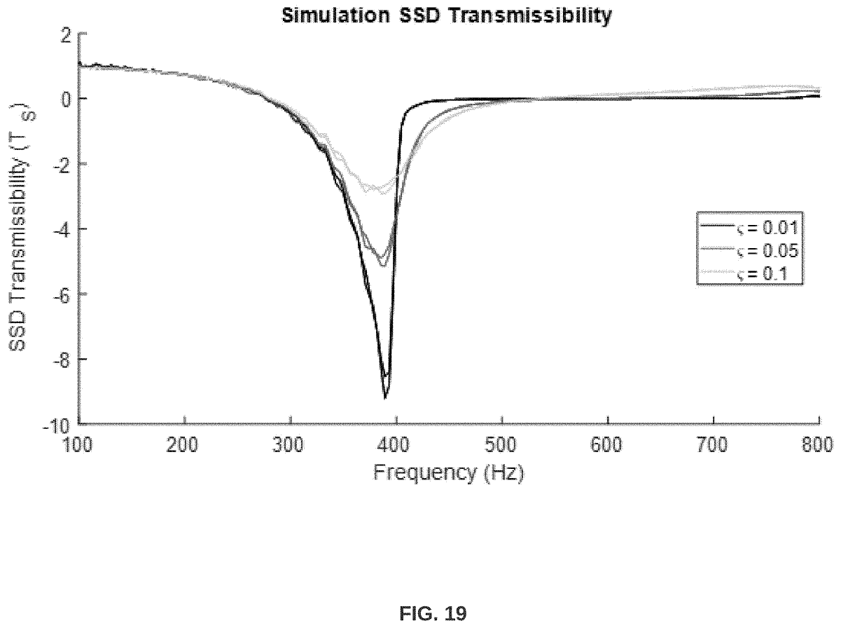

FIG. 19 shows six skewness transmissibilities of Equation (14). The Gaussian squared distribution could not be included because it is a symmetric distribution (i.e. the denominator is near-zero). The results appear to show a transmissibility solely a function of natural frequency and damping. The maximum peak of the curve is below the simulation resonance of 400 Hz.

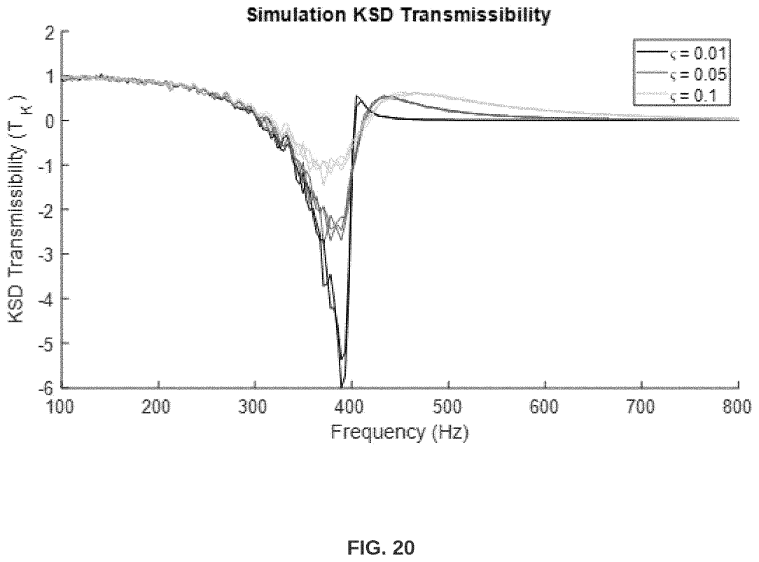

FIG. 20 shows nine kurtosis transmissibilities of Equation (15). The results appear to show a transmissibility that is solely a function of natural frequency and damping. Like skewness, the peaks are not at the resonance frequency.

FIG. 18 affirms the filter-ensemble method for spectral density estimation by obtaining near-identical results to analytical methods of FIG. 15. FIGS. 19 and 20 appear to show transmissibilities of information (skewness and kurtosis) that are functions of the mass-spring-damper (natural frequency and critical damping), and are not functions of the distribution of the input P(y). The functions appear to be simple, which may mean that it is possible to derive an analytical expression.

The following table shows results of simulations of explicit and implicit analyses.

| | Execution Time | Variance | | |
|---|---|---|---|---|
| Simulation | (ms) | (Power) | Skewness | Kurtosis |
| Explicit 100 | 9.12 | 2.29 | −0.334 | 4.57 |
| Second Simulation | | | | |
| Implicit 100 | 0.03 | 2.29 | −0.326 | 4.7 |
| Second Simulation | | | | |
| Explicit 1,000 | 83.54 | 2.32 | −0.389 | 5.36 |
| Second Simulation | | | | |
| Implicit 1,000 | 0.025 | 2.32 | −0.389 | 5.36 |
| Second Simulation | | | | |

From the foregoing table, ordinarily skilled artisans will appreciate that execution times of explicit analyses are proportional to the duration of the simulation and are generally more computationally intensive than implicit analyses are. Moreover, the table indicates that the explicit analysis results themselves are comparable to the implicit analysis results. Consequently, using techniques according to embodiments of the present invention, it is possible to obtain the same results with far lower computational requirements.

In the foregoing, it should be noted that the times shown are for a single spring mass damper element. Simulations can combine thousands to millions of elements in structural simulations.

Case Study 5: Source Separation of a Mixed Gaussian and Non-Gaussian signal

This case study was directed to obtaining a more quantitative statement of source separation, involving analyzing a signal with known Gaussian and non-Gaussian behavior in the frequency domain. The Gaussian waveform can be filtered to operate in one frequency range, while the non-Gaussian can be filtered to operate in another frequency range.

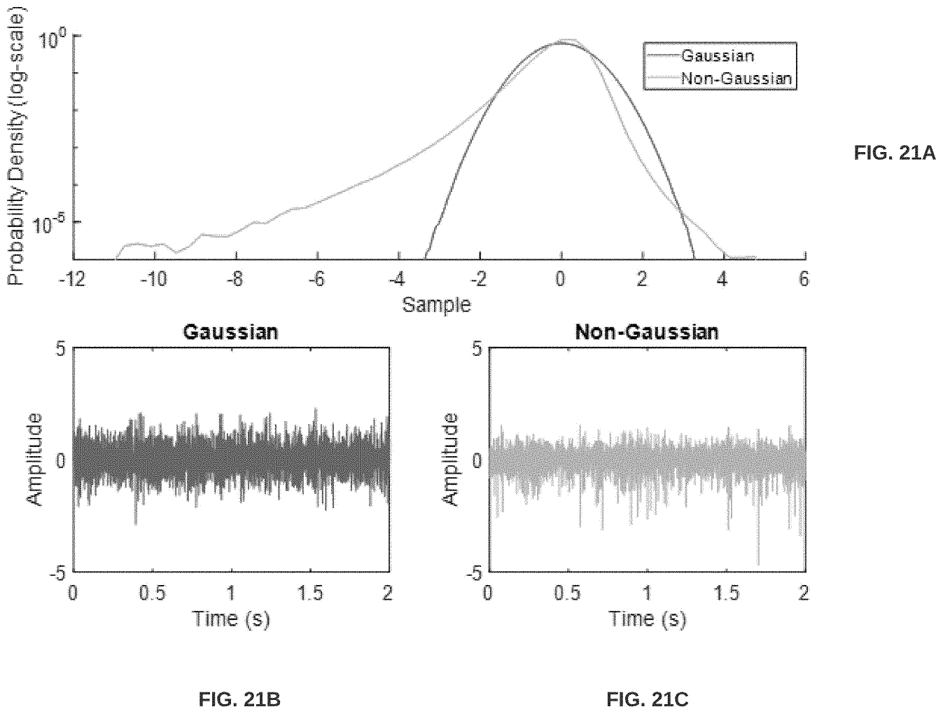

This case study involved setting up the following simulation:
Matlab randn to create a Gaussian waveform as seen in FIG. 21B
   Interpolate and band-pass filter to simulate a dynamic bandwidth of 50 to 100 Hz.
   Resample to have a virtual sampling rate of 3,000 Hz.
Matlab lograndn to create a non-Gaussian waveform as seen in FIG. 21C
   Interpolate and band-pass filter to simulate a dynamic bandwidth of 100 to 500 Hz.
   Resample to have a virtual sampling rate of 3,000 Hz.
Mix the signals, where the mixed signal will be Gaussian at lower frequencies and non-Gaussian at higher frequencies.

FIG. 21A shows resulting probability density estimates of the discrete signals from FIGS. 21B and 21C. As can be seen, the non-Gaussian signal of FIG. 21C has observable extremes, negative skewness, and higher kurtosis than does the Gaussian signal of FIG. 21B. In this case study, both the Gaussian and the non-Gaussian signals were bandpassed and scaled so as nominally to have the same power spectral density. A priori, a SSD and KSD analysis would be expected to show 0 skewness and 3.0 kurtosis at lower frequencies, and negative skewness and increasing kurtosis at higher frequencies.

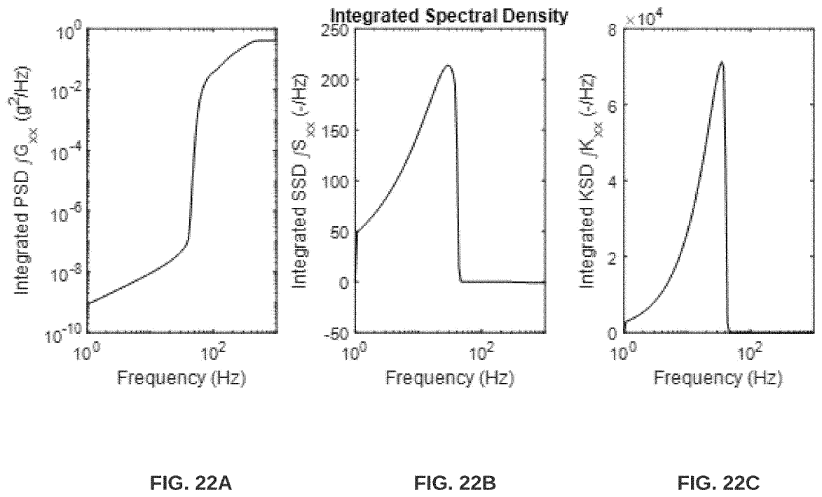

A filter ensemble of the type illustrated in FIG. 2 produces integrated spectral density graphs as shown in FIGS. 22A to 22C. The integrated PSD of FIG. 22A shows that variance is contributed principally from 50 to 500 Hz. Normalizing values to power results in large changes in shape, where dividing by a small value (below 50 Hz) results in a large and unrealistic value.

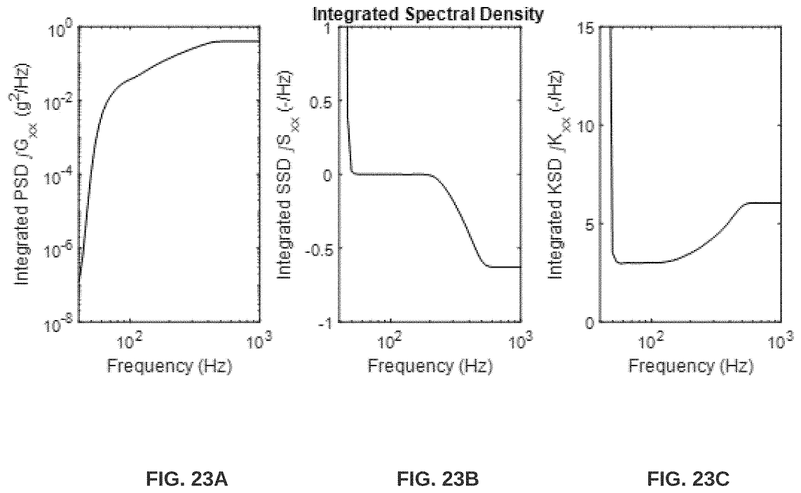

FIGS. 22A to 22C appear to show large shape values in the filtered region below 50 Hz, and near-zero values elsewhere. Given the tracking of large changes to shape in a region where the signal should be near-zero, it is reasonable to assume that these large values are ignorable. Accordingly, FIGS. 23A to 23C show a “zoom-in” on the graphs of FIGS. 22A to 22C to show only integrated spectral densities where appreciable energy (>50 Hz) is present. Looking at FIGS. 23A to 23C, consistent with what was intended to be accomplished, it can be seen that the Gaussian range (50-100 Hz) does not contribute to skewness and keeps the signal kurtosis near 3.0, while the non-Gaussian range (100-500) lowers skewness and increases kurtosis. As values approach the Nyquist frequency, all integrated spectral densities approach the discrete signal scalars of variance, skewness, and kurtosis per a Parseval-like conservation of information.

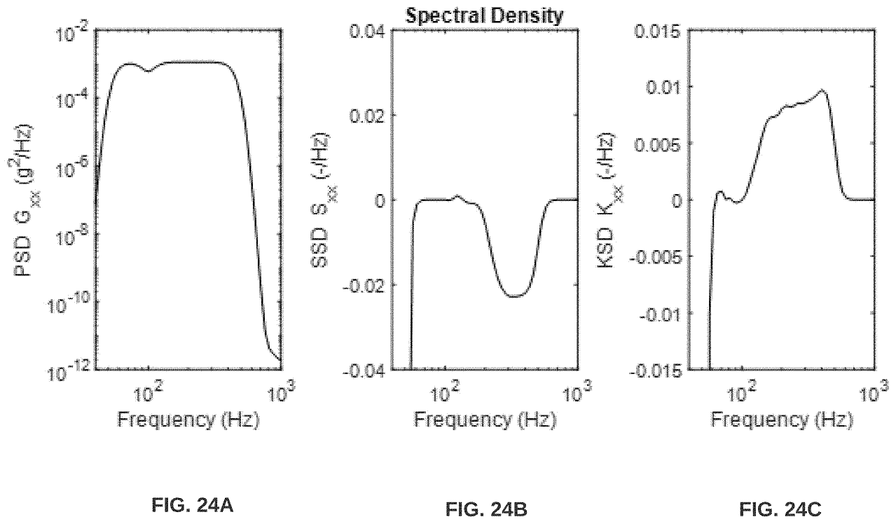

FIGS. 24A to 24C show signal spectral density, achieved by numerically differentiating with respect to frequency. In FIGS. 24A to 24C, PSD, SSD, and KSD are zoomed to look above 50 Hz. These Figures lead to the same conclusions of skewness and kurtosis contributions of the mixed Gaussian and non-Gaussian signals: That the Gaussian range (50-100 Hz) and non-Gaussian range (100-500 Hz) have the same PSD amplitude; that the Gaussian frequencies of the signal do not significantly change skewness or kurtosis; and that the non-Gaussian signal contributes negative skew and higher kurtosis (as expected).

FIGS. 22A to 22C show a challenge toward viewing data with large changes in shape in signal noise. Working with standardized moment spectral densities (such as SSD or KSD) can be convenient for non-dimensional interpretations of signals, but as an alternative, it is possible to work with central moment spectral densities such as third moment

$$( {μ}_{3 , xx} ( f ) = \frac{d}{df} {μ}_{3} ( f ) )$$

or fourth moment

$$( {μ}_{4 , xx} ( f ) = \frac{d}{df} {μ}_{4} ( f ) ) .$$

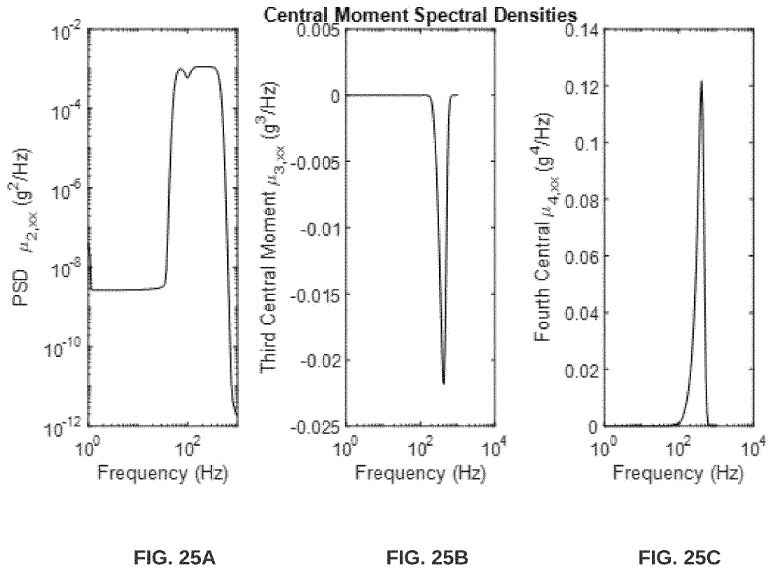

Central moment spectral densities contain information regarding shape and variance, which means near-zero values of the PSD make the central moment values also near zero, in turn meaning that the noise distortions of FIGS. 22A to 22C are not observable. However, non-standardized moments may be difficult to interpret because of the units (g³/Hz or g⁴/Hz), as shown in FIGS. 25A to 25C.

Following are areas, in addition to the ones reflected in the foregoing case studies, to which the inventive technique might be applied.

Dynamic Environment Characterization—A vehicle, such as an airplane or an automobile, frequently experiences shock and/or vibration. Normally, before putting such a vehicle out in the field, a manufacturer will capture dynamic environments data (shock and vibration) to compare the data against the levels that the design can withstand. Raw data is generally too ‘dense’ for direct use and is generally converted to a PSD prior to design or test use. Additionally, raw data cannot be ‘enveloped’ to a worst-case scenario, which is generally desired by a design agent to ensure product margin for use. By only using the PSD for modeling and extremes, characterizing the environment may or may not be conservative. Application of techniques according to aspects of the present invention can add a dimension of information that is 1) less processing intensive to use than raw data in analysis, and 2) allow statistical enveloping (Maximum Expected Environment similar to NASA-HDBK-7005) for characterization, which 3) prevents over and under designing a product.

Shaker testing and control—Shaker testing is used in many industries including aerospace, automotive, civil (earthquake and buildings), and consumer product ruggedization, qualify product worthiness prior to giving the product to a customer. For automotive/consumer products, shaker testing generally is intended to validate a warranty before mass production. Conventional shaker tests only use the PSD as an input, where the PSD comes from a characterization step. Application of techniques according to aspects of the present invention may provide better characterization, making the techniques useful in a shaker controller in a test laboratory.

Finite Element Analysis (FEA)—FEA is the computer modeling of structure commonly in use in the mechanical engineering discipline to predict the design margin of a product independent of testing. FEA assumes a signal is either sinusoidal or Gaussian. Application of techniques according to aspects of the present invention can create a new ‘Element’ that can use a non-Gaussian spectral parameter, yielding more accurate predictions of stress in a material (e.g. the stress in an aircraft under flight). Increased predictive accuracy can help to prevent over and under designs of a product.

Other Sound Recognition—Similarly to the acoustic kinds of problems discussed above, a similar kind of recognition problem can be seen in applications such as SONAR signature analysis for target identification, for example, the class/nationality of a submarine. As also discussed earlier, applications of AI to sound recognition can require tremendous processing power and enormous amounts of ground truth (human intervention) to succeed. Application of techniques according to aspects of the present invention can augment sound recognition as a physics-based ‘dimensionality reduction’ prior to application of AI, to improve prediction accuracy while reducing the ambiguity of what the AI is doing.

Structural Health Monitoring—Similarly to the situation discussed above with respect to Case Study 1 involving machinery, structures have their own natural modes of vibration. For particular structures such as bridges, changes in natural vibration modes may signify faults such as cracks. Here again, looking at the fourth moment (kurtosis/KSD) in accordance with aspects of the present invention, rather than the second moment (variance/PSD) can enable discernment of extremes, and hence of potential or actual structural faults.

Quantitative Finance—Modern Portfolio Theory (MPT) has come increasingly into vogue. Current MPT analyses assume Gaussian distribution of returns. Such distributions often are non-Gaussian, however. Application of SSD or KSD, for example, to MPT can help to improve risk/reward projections, helping to anticipate extreme events such as market crashes. In this manner, it can be possible to optimize a portfolio for periods of time (short term vs. long term), and better accommodate transient responses such as market crashes.

Gravity Wave Background Radiation—In the course of research by the Laser Interferometer Gravitational Observatory (LIGO) into gravity waves, one focus is on background radiation of gravity waves, possibly resulting from the remnants of the Big Bang. Application of aspects of the present invention in this area can lead to new inferences as to the shape of the universe.

Aspects of some embodiments of the invention are set out in the following clauses:

CLAUSE 1. A computer-implemented signal processing system to analyze vibrations in machinery, the computer-implemented signal processing system comprising:
one or more sensors to receive input vibration signals from the machinery; and
a computer-implemented signal processor to receive the input vibration signals from the one or more sensors, to process the input vibration signals, and to output one of skewness spectral density (SSD), kurtosis spectral density (KSD), or probability density spectral density (PDSD) analysis of the input vibration signals to enable identification of an operational status of one or more components of the machinery.
   CLAUSE 2. A computer-implemented signal processing system according to clause 1, wherein the identification indicates prospective failure of one or more of the components of the machinery.
   CLAUSE 3. A computer-implemented signal processing system according to clause 1, wherein the machinery comprises apparatus selected from the group consisting of a pump, a compressor, a fan, an engine, or one or more components from said apparatus, said one or more components selected from the group consisting of a valve, an opening or orifice, or a joint.
   CLAUSE 4. A computer-implemented signal processing system according to clause 4, wherein the operational status includes fluid flow through one of the pump, compressor, engine, or one or more components from said apparatus.
   CLAUSE 5. A computer-implemented signal processing system to analyze sound, the computer-implemented signal processing system comprising:
one or more sensors to receive input sound signals; and
a computer-implemented signal processor to receive the input sound signals, to process the input sound signals, and to output one of skewness spectral density (SSD), kurtosis spectral density (KSD), or probability density spectral density (PDSD) analysis of the input sound signals to enable distinction among sounds represented by the input sound signals.
   CLAUSE 6. A computer-implemented signal processing system according to clause 5, wherein the distinction among sounds includes differentiation of each of the sounds from the remaining sounds.
   CLAUSE 7. A computer-implemented signal processing system according to clause 6, wherein the differentiation comprises an identification of sound differences among machinery.
   CLAUSE 8. A computer-implemented signal processing system according to clause 7, wherein the machinery comprises apparatus selected from the group consisting of a pump, a compressor, a fan, an engine, or one or more components from said apparatus, said one or more components selected from the group consisting of a valve, an opening or orifice, or a joint.
   CLAUSE 9. A computer-implemented signal processing system according to clause 6, wherein the differentiation comprises an identification of a timbre of a voice of each of a plurality of individuals.
   CLAUSE 10. A computer-implemented signal processing system according to clause 6, wherein the differentiation comprises an identification of different ones of a plurality of musical instruments.
   CLAUSE 11. A computer-implemented signal processing system to analyze vibrations in structures, the computer-implemented signal processing system comprising:
one or more sensors to receive input vibration signals from the structures; and
a computer-implemented signal processor to receive the input vibration signals from the one or more sensors, to process the input vibration signals, and to output one of skewness spectral density (SSD), kurtosis spectral density (KSD), or probability density spectral density (PDSD) analysis of the input vibration signals to enable identification of a condition of one or more components of the structures.
   CLAUSE 12. A computer-implemented signal processing system according to clause 11, wherein the identification indicates prospective failure of one or more of the components of the structures.
   CLAUSE 13. A computer-implemented signal processing system according to any preceding clause, wherein the one or more sensors is selected from the group consisting of accelerometers or other acceleration sensors, vibrometers or other vibration sensors, strain gauges, pressure sensors, flow sensors, acoustic sensors, and microphones.
   CLAUSE 14. A computer-implemented signal processing system to perform quantitative financial analysis, the computer-implemented signal processing system comprising:
a computer-implemented signal processor to receive input financial data, to process the input financial data, and to output one of skewness spectral density (SSD), kurtosis spectral density (KSD), or probability density spectral density (PDSD) analysis of the input financial data to identify trends in the financial data.
   CLAUSE 15. A computer-implemented signal processing system to simulate turbulence, the computer-implemented signal processing system comprising:
a computer-implemented signal processor to receive input turbulence data from a turbulence source, to process the input turbulence data, and to output one of skewness spectral density (SSD), kurtosis spectral density (KSD), or probability density spectral density (PDSD) analysis of the input turbulence data to identify characteristics of the turbulence.
   CLAUSE 16. A computer-implemented signal processing system according to any preceding clause, wherein the SSD is computed as follows:

$${S}_{xx} ( f ) = \frac{d}{df} \frac{{μ}_{3} ( f )}{{( {μ}_{2} ( f ) )}^{\frac{3}{2}}}$$

where
Sₓₓ is SSD;
f is a continuous or a discrete frequency;
μ₂ is a scalar for a second central moment; and
μ₃ is a scalar for a third central moment.
   CLAUSE 17. A computer-implemented signal processing system according to any preceding clause, wherein the KSD is computed as follows:

$${K}_{xx} ( f ) = \frac{d}{df} \frac{{μ}_{4} ( f )}{{( {μ}_{2} ( f ) )}^{2}}$$

where
Kₓₓ is KSD;
f is a continuous or a discrete frequency;
μ₂ is a scalar for a second central moment; and
μ₄ is a scalar for a fourth central moment.
   CLAUSE 18. A computer-implemented signal processing system according to any preceding clause, wherein the PDSD is computed as follows:

$${P}_{xx} ( f ) = \frac{d}{df} P ( x , f )$$

where
Pₓₓ is PDSD;
f is a continuous or a discrete frequency;
P is probability density; and
x is a point on a waveform corresponding to the signals or data.
   CLAUSE 19. A computer-implemented signal processing system according to any preceding clause, wherein the computer-implemented signal processor comprises at least one processor and non-transitory memory to store inputs to the at least one processor, the non-transitory memory storing a plurality of instructions which, when executed by the at least one processor, perform the one of the SSD, KSD, and PDSD.
   CLAUSE 20. A computer-implemented signal processing method to analyze vibrations in machinery, the computer-implemented signal processing method comprising:
receiving input vibration signals of the machinery from one or more sensors;
receiving, via a computer-implemented signal processor, the input vibration signals from the one or more sensors;
processing, via the computer-implemented signal processor, the input vibration signals; and
outputting one of skewness spectral density (SSD), kurtosis spectral density (KSD), or probability density spectral density (PDSD) analysis of the input vibration signals to enable identification of an operational status of one or more components of the machinery.
   CLAUSE 21. A computer-implemented signal processing method according to clause 1, wherein the identification indicates prospective failure of one or more of the components of the machinery.
   CLAUSE 22. A computer-implemented signal processing method according to clause 1, wherein the machinery comprises apparatus selected from the group consisting of a pump, a compressor, a fan, an engine, or one or more components from said apparatus, said one or more components selected from the group consisting of a valve, an opening or orifice, or a joint.
   CLAUSE 23. A computer-implemented signal processing method according to clause 20, wherein the operational status includes fluid flow through one of the pump, compressor, engine, or one or more components from said apparatus.
   CLAUSE 24. A computer-implemented signal processing method to analyze sound, the computer-implemented signal processing method comprising:
receiving input sound signals from one or more sensors;
receiving, via a computer-implemented signal processor, the input sound signals from the one or more sensors;
processing, via the computer-implemented signal processor, the input sound signals; and outputting one of skewness spectral density (SSD), kurtosis spectral density (KSD), or probability density spectral density (PDSD) analysis of the input sound signals to enable distinction among sounds represented by the input sound signals.
   CLAUSE 25. A computer-implemented signal processing method according to clause 24, wherein the distinction among sounds includes differentiation of each of the sounds from the remaining sounds.
   CLAUSE 26. A computer-implemented signal processing method according to clause 25, wherein the differentiation comprises an identification of sound differences among machinery.
   CLAUSE 27. A computer-implemented signal processing method according to clause 26, wherein the machinery comprises apparatus selected from the group consisting of a pump, a compressor, a fan, an engine, or one or more components from said apparatus, said one or more components selected from the group consisting of a valve, an opening or orifice, or a joint.
   CLAUSE 28. A computer-implemented signal processing method according to clause 27, wherein the differentiation comprises an identification of a timbre of a voice of each of a plurality of individuals.
   CLAUSE 29. A computer-implemented signal processing method according to clause 27, wherein the differentiation comprises an identification of different ones of a plurality of musical instruments.
   CLAUSE 30. A computer-implemented signal processing method to analyze vibrations in structures, the computer-implemented signal processing method comprising:
receiving input vibration signals from the structures from one or more sensors;
receiving, via a computer-implemented signal processor, the input vibration signals from the one or more sensors;
processing, via the computer-implemented signal processor, the input vibration signals; and
outputting one of skewness spectral density (SSD), kurtosis spectral density (KSD), or probability density spectral density (PDSD) analysis of the input vibration signals to enable identification of a condition of one or more components of the structures.
   CLAUSE 31. A computer-implemented signal processing method according to clause 30, wherein the identification indicates prospective failure of one or more of the components of the structures.
   CLAUSE 32. A computer-implemented signal processing method according to any of clauses 20 to 31, wherein the one or more sensors is selected from the group consisting of accelerometers or other acceleration sensors, vibrometers or other vibration sensors, strain gauges, pressure sensors, flow sensors, acoustic sensors, and microphones.
   CLAUSE 33. A computer-implemented signal processing method to perform quantitative financial analysis, the computer-implemented signal processing method comprising:
receiving, via a computer-implemented signal processor, input financial data;
processing, via the computer-implemented signal processor, the input financial data; and
outputting one of skewness spectral density (SSD), kurtosis spectral density (KSD), or probability density spectral density (PDSD) analysis of the input financial data to identify trends in the financial data.
   CLAUSE 34. A computer-implemented signal processing method to simulate turbulence, the computer-implemented signal processing method comprising:
receiving, via a computer-implemented signal processor, input turbulence data from a turbulence source;
processing, via the computer-implemented signal processor, the input turbulence data; and
outputting one of skewness spectral density (SSD), kurtosis spectral density (KSD), or probability density spectral density (PDSD) analysis of the input turbulence data to identify characteristics of the turbulence.
   CLAUSE 35. A computer-implemented signal processing method according to any of clauses 20 to 34, wherein the SSD is computed as follows:

$${S}_{xx} ( f ) = \frac{d}{df} \frac{{μ}_{3} ( f )}{{( {μ}_{2} ( f ) )}^{\frac{3}{2}}}$$

where
Sₓₓ is SSD;
f is a continuous or a discrete frequency;
μ₂ is a scalar for a second central moment; and
μ₃ is a scalar for a third central moment.
   CLAUSE 36. A computer-implemented signal processing method according to any of clauses 20 to 35, wherein the KSD is computed as follows:

$${K}_{xx} ( f ) = \frac{d}{df} \frac{{μ}_{4} ( f )}{{( {μ}_{2} ( f ) )}^{2}}$$

where
Kₓₓ is KSD;
f is a continuous or a discrete frequency;
μ₂ is a scalar for a second central moment; and
μ₄ is a scalar for a fourth central moment.
   CLAUSE 37. A computer-implemented signal processing method according to any of clauses 20 to 36, wherein the PDSD is computed as follows:

$${P}_{xx} ( f ) = \frac{d}{df} P ( x , f )$$

where
Pₓₓ is PDSD;
f is a continuous or a discrete frequency;
P is probability density; and
x is a point on a waveform corresponding to the signals or data.
   CLAUSE 38. A computer-implemented signal processing method according to any of clauses 20 to 37, wherein the computer-implemented signal processor comprises at least one processor and non-transitory memory to store inputs to the at least one processor, the non-transitory memory storing a plurality of instructions which, when executed by the at least one processor, perform the one of the SSD, KSD, and PDSD.

While the invention has been described in detail above with reference to several embodiments, ordinarily skilled artisans will appreciate that variations within the scope and spirit of the invention are possible. Accordingly, the invention should be construed as limited only by the scope of the following claims.

What is claimed is:

1. A computer-implemented signal processing system to analyze sound, the computer-implemented signal processing system comprising:
one or more sensors to receive input sound signals; and
a computer-implemented signal processor to receive the input sound signals, to process the input sound signals, and to output one of skewness spectral density (SSD), kurtosis spectral density (KSD), or probability density spectral density (PDSD) analysis of the input sound signals to enable distinction among sounds represented by the input sound signals,
wherein the computer-implemented signal processor comprises at least one processor and non-transitory memory to store inputs to the at least one processor, the non-transitory memory storing a plurality of instructions which, when executed by the at least one processor, perform the one of the SSD, KSD, and PDSD.

2. A computer-implemented signal processing system according to claim 1, wherein the distinction among sounds includes differentiation of each of the sounds from the other sounds.

3. A computer-implemented signal processing system according to claim 1, wherein the input sound signals comprise input vibration signals from machinery, and wherein the analysis of the input sound signals enables identification of vibrations in machinery.

4. A computer-implemented signal processing system according to claim 1, wherein the input sound signals comprise input vibration signals from machinery, and wherein the analysis of the input sound signals enables identification of an operational status of one or more components of the machinery.

5. A computer-implemented signal processing system according to claim 4, wherein the machinery comprises apparatus selected from the group consisting of a pump, a compressor, a fan, an engine, or one or more components from said apparatus, said one or more components selected from the group consisting of a valve, an opening or orifice, or a joint.

6. A computer-implemented signal processing system according to claim 4, wherein the operational status includes fluid flow through one of the pump, the compressor, the engine, the valve, the opening or orifice, or the joint.

7. A computer-implemented signal processing system according to claim 3, wherein the identification of vibrations in the machinery indicates prospective failure of one or more of the components of the machinery.

8. A computer-implemented signal processing system according to claim 1, wherein the input sound signals comprises input vibration signals from structures, and wherein the analysis of the input sound signals enables an identification of vibrations in structures.

9. A computer-implemented signal processing system according to claim 8, wherein the identification of vibrations in the structures indicates prospective failure of one or more of the components of the structures.

10. A computer-implemented signal processing system according to claim 1, wherein the one or more sensors is selected from the group consisting of accelerometers or other acceleration sensors, vibrometers or other vibration sensors, strain gauges, pressure sensors, flow sensors, acoustic sensors, and microphones.

11. A computer-implemented signal processing system according to claim 1, wherein the SSD is computed as follows:
$${S}_{xx} ( f ) = \frac{d}{df} \frac{{μ}_{3} ( f )}{{( {μ}_{2} ( f ) )}^{\frac{3}{2}}}$$
where
Sₓₓ is SSD;
f is a continuous or a discrete frequency;
μ₂ is a scalar for a second central moment; and
μ₃ is a scalar for a third central moment.

12. A computer-implemented signal processing system according to claim 1, wherein the KSD is computed as follows:
$${K}_{xx} ( f ) = \frac{d}{df} \frac{{μ}_{4} ( f )}{{( {μ}_{2} ( f ) )}^{2}}$$
where
Kₓₓ is KSD;
f is a continuous or a discrete frequency;
μ₂ is a scalar for a second central moment; and
μ₄ is a scalar for a fourth central moment.

13. A computer-implemented signal processing system according to claim 1, wherein the PDSD is computed as follows:
$${P}_{xx} ( f ) = \frac{d}{df} P ( x , f )$$
where
Pₓₓ is PDSD;
f is a continuous or a discrete frequency;
P is probability density; and
x is a point on a waveform corresponding to the signals or data.

14. A computer-implemented signal processing method to analyze sound, the computer-implemented signal processing method comprising:
receiving input sound signals from one or more sensors;
receiving, via a computer-implemented signal processor, the input sound signals from the one or more sensors;
processing, via the computer-implemented signal processor, the input sound signals; and
outputting one of skewness spectral density (SSD), kurtosis spectral density (KSD), or probability density spectral density (PDSD) analysis of the input sound signals to enable distinction among sounds represented by the input sound signals.

15. A computer-implemented signal processing method according to claim 14, wherein the input sound signals comprises input vibration signals from machinery, and wherein the analysis of the input sound signals enables an identification of vibrations in machinery.

16. A computer-implemented signal processing method according to claim 15, wherein the identification indicates prospective failure of one or more of the components of the machinery.

17. A computer-implemented signal processing method according to claim 15, wherein the machinery comprises apparatus selected from the group consisting of a pump, a compressor, a fan, an engine, or one or more components from said apparatus, said one or more components selected from the group consisting of a valve, an opening or orifice, or a joint.

18. A computer-implemented signal processing method according to claim 14, wherein the input sound signals comprises input vibration signals from structures, and wherein the analysis of the input sound signals enables an identification of vibrations in structures.

19. A computer-implemented signal processing method according to claim 18, wherein the identification indicates prospective failure of one or more of the components of the structures.

20. A computer-implemented signal processing method according to claim 14, wherein the one or more sensors is selected from the group consisting of accelerometers or other acceleration sensors, vibrometers or other vibration sensors, strain gauges, pressure sensors, flow sensors, acoustic sensors, and microphones.
